(19) United States
(12) Patent Application Publication
(10) Pub. No.: US 2022/0235446 A1
(43) Pub. Date: Jul. 28, 2022

(54) SOFT MAGNETIC ALLOY AND MAGNETIC COMPONENT

(71) Applicant: TDK CORPORATION, Tokyo (JP)

(72) Inventors: Hajime AMANO, Tokyo (JP); Kazuhiro YOSHIDOME, Tokyo (JP); Hiroyuki MATSUMOTO, Tokyo (JP)

(73) Assignee: TDK CORPORATION, Tokyo (JP)

(21) Appl. No.: 17/614,397

(22) PCT Filed: Mar. 26, 2020
(86) PCT No.: PCT/JP2020/013691

§ 371 Date: Nov. 26, 2021

(30) Foreign Application Priority Data
May 31, 2019 (JP) 2019-102173

(51) Int. Cl. C22C 45/02; H01F 1/153

(52) U.S. Cl. CPC C22C 45/02; C22C 2202/02; C22C 2200/02; H01F 1/15308

(57) ABSTRACT

A soft magnetic alloy having high saturation magnetic flux density Bs and low coercivity Hc, and a composition having formula (Fe(1−(α+β))X1αX2β)(1−(a+b+c))MaCbX3c; X1 represents one selected from the group of Co and Ni; X2 represents one selected from the group of Al, Mn, Ag, Zn, Sn, As, Sb, Cu, Cr, Bi, N, O, S, and rare earth elements; M represents one selected from the group of Ta, V, Zr, Hf, Ti, Nb, Mo, and W; X3 represents one selected from the group of P, B, Si, and Ge; and 0≤a≤0.140, 0.005≤b≤0.200, 0<c≤0.180, 0≤d≤0.020, 0.300≤b/(b+c)<1.000, 0≤α(1−(a+b+c))≤0.400, β≥0,0≤α+β≤0.50 are satisfied.

### TECHNICAL FIELD

The present invention relates to a soft magnetic alloy and a magnetic component.

### BACKGROUND

Patent Document 1 discloses an invention of a Fe based soft magnetic alloy powder. Specifically, Patent Document 1 discloses that the Fe based soft magnetic alloy powder having a high performance coefficient and a high permeability suitable for a magnetic sheet can be obtained by setting a composition within a specific range and setting a crystal structure as a specific crystal structure.

Patent Document 2 discloses an invention of a soft magnetic alloy having a high permeability and a high saturation magnetic flux density. Specifically, Patent Document 2 discloses that the soft magnetic alloy having the high permeability and the high saturation magnetic flux density suitable for a soft magnetic alloy for a transformer can be obtained by setting a composition within a specific range.
[Patent Document 1] Japanese Patent No. 5490556
[Patent Document 2] Japanese Patent Laid-Open No. 2002-30398

### SUMMARY

An object of the present invention is to provide a soft magnetic alloy having a high saturation magnetic flux density Bs and a low coercivity Hc.

### Solution to Problem

In order to attain the above object, a soft magnetic alloy according to a first aspect of the present invention is

a soft magnetic alloy including a composition having a formula (Fe_{(1-(α+β))}X1_{α}X2_{β})_{(1-(a+b+c))}MₐC_{b}X3_{c}, in which

X1 represents at least one selected from a group consisting of Co and Ni,

X2 represents at least one selected from a group consisting of Al, Mn, Ag, Zn, Sn, As, Sb, Cu, Cr, Bi, N, O, S, and rare earth elements,

M represents at least one selected from a group consisting of Ta, V, Zr, Hf, Ti, Nb, Mo, and W,

X3 represents at least one selected from a group consisting of P, B, Si, and Ge, and

0≤a≤0.140,

0.005≤b≤0.200,

0<c≤0.180,

0.300≤b/(b+c)<1.000,

0≤α(1−(a+b+c))≤0.400,

β≥0,

0≤α+β≤0.50 are satisfied, wherein

the soft magnetic alloy has a structure including a Fe based nanocrystal.

Since the soft magnetic alloy according to the present invention has the above composition and a microstructure, it can obtain a high saturation magnetic flux density Bs and a low coercivity Hc.

In order to achieve the above-mentioned object, a soft magnetic alloy according to a second aspect of the present invention is

a soft magnetic alloy including a composition having a formula (Fe_{(1-(α+β))}X1_{α}X2_{β})_{(1-(a+b+c))}MₐC_{b}X3_{c}, in which

X1 represents at least one selected from a group consisting of Co and Ni,

X2 represents at least one selected from a group consisting of Al, Mn, Ag, Zn, Sn, As, Sb, Cu, Cr, Bi, N, O, S, and rare earth elements,

M represents at least one selected from a group consisting of Ta, V, Zr, Hf, Ti, Nb, Mo, and W,

X3 represents at least one selected from a group consisting of P, B, Si, and Ge, and

0≤a≤0.140,

0.005≤b≤0.200,

0≤c≤0.180,

0.300≤b/(b+c)<1.000,

0≤α(1−(a+b+c))≤0.400,

β≥0,

0≤α+β≤0.50 are satisfied, wherein

the soft magnetic alloy has a nano-heterostructure in which a microcrystal is present in an amorphous material.

The soft magnetic alloy according to the first aspect can be obtained by heat-treating the soft magnetic alloy according to the second aspect. In other words, the soft magnetic alloy according to the second aspect is a raw material of the soft magnetic alloy according to the first aspect.

The soft magnetic alloy according to the present invention may satisfy b≥c.

The soft magnetic alloy according to the present invention may satisfy 0.050≤a≤0.140.

The soft magnetic alloy according to the present invention may satisfy 0.730≤(1−(a+b+c))≤0.930.

The soft magnetic alloy according to the present invention may have a ribbon shape.

The soft magnetic alloy according to the present invention may have a shape in a powder form.

The soft magnetic alloy according to the present invention may have a thin film shape.

A magnetic component according to the present invention is made of any one of the soft magnetic alloys described above.

### BRIEF DESCRIPTION OF THE DRAWINGS

FIG. 1 is an example of a chart obtained by X-ray crystal structure analysis of a ribbon.

FIG. 2 is an example of a pattern obtained by profile fitting the chart of FIG. 1.

FIG. 3 is an example of a chart obtained by X-ray crystal structure analysis of a thin film.

FIG. 4 is an example of a chart obtained by X-ray crystal structure analysis of a thin film.

FIG. 5 shows a composition dependence of a crystal state of a Fe—Nb—B bulk.

### DETAILED DESCRIPTION

Hereinafter, the present invention is described based on embodiments shown in drawings.

A soft magnetic alloy according to a first embodiment of the present invention is

a soft magnetic alloy including a composition having a formula (Fe_{(1-(α+β))}X1_{α}X2_{β})_{(1-(a+b+c))}MₐC_{b}X3_{c}, in which

X1 represents at least one selected from a group consisting of Co and Ni,

X2 represents at least one selected from a group consisting of Al, Mn, Ag, Zn, Sn, As, Sb, Cu, Cr, Bi, N, O, S, and rare earth elements,

M represents at least one selected from a group consisting of Ta, V, Zr, Hf, Ti, Nb, Mo, and W,

X3 represents at least one selected from a group consisting of P, B, Si, and Ge, and

0≤a≤0.140,

0.005≤b≤0.200,

0≤c≤0.180,

0.300≤b/(b+c)<1.000,

0≤α(1−(a+b+c))≤0.400,

β≥0,

0≤α+β≤0.50 are satisfied, wherein

the soft magnetic alloy has a structure including a Fe based nanocrystal.

Since the soft magnetic alloy according to the present embodiment has the composition within the above range, the soft magnetic alloy has a high saturation magnetic flux density Bs and a low coercivity Hc.

The Fe based nanocrystal is a crystal having a particle size of a nano-order and a Fe crystal structure of bcc (body-centered cubic lattice structure). In the present embodiment, it is preferable to deposit the Fe based nanocrystal having an average particle size of 5 to 30 nm. In the present embodiment, when the soft magnetic alloy has a structure including the Fe based nanocrystal, the soft magnetic alloy may be made of a crystal.

In addition, when a soft magnetic alloy having the above composition and made of an amorphous material is subjected to heat treatment, the Fe based nanocrystal is likely to be deposited in the soft magnetic alloy. In other words, the soft magnetic alloy having the above composition and made of the amorphous material can be easily used as a raw material for the soft magnetic alloy according to the present embodiment having the structure including the Fe based nanocrystal.

In addition, the soft magnetic alloy before subjected to the heat treatment having the above composition may have a structure including only an amorphous material, or may have a nano-heterostructure in which microcrystals are present in an amorphous material. A soft magnetic alloy having the above composition and having a nano-heterostructure is a soft magnetic alloy according to a second embodiment of the present invention. That is, the soft magnetic alloy according to the first embodiment can be obtained by heat-treating the soft magnetic alloy according to the second embodiment. In other words, the soft magnetic alloy according to the second embodiment is a raw material of the soft magnetic alloy of the first embodiment. The microcrystals may have an average particle size of 0.3 nm to 10 nm.

Hereinafter, a method for confirming whether a soft magnetic alloy has a structure including amorphous material (a structure including only an amorphous material or a nano-heterostructure) or a structure including a crystal will be described.

When the soft magnetic alloy according to the present embodiment is a bulk described later, the soft magnetic alloy having an amorphization rate X of 85% or more represented by the following equation (1) has a structure including an amorphous material, and the soft magnetic alloy having an amorphization rate X of less than 85% has a structure including a crystal.

X=100−(Ic/(Ic+Ia)×100) (1)

Ic: crystal scattering integrated intensity

Ia: amorphous scattering integrated intensity

The amorphization rate X is calculated according to the above equation (1) by performing X-ray crystal structure analysis on the soft magnetic alloy by using XRD to identify a phase, reading a peak (Ic: crystal scattering integrated intensity, Ia: amorphous scattering integrated intensity) of crystallized Fe or a crystallized compound, and calculating a crystallization rate based on the peak intensities. Hereinafter, the calculation method will be described in more detail.

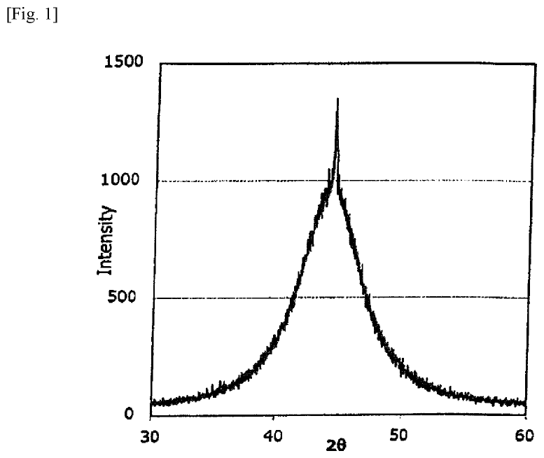

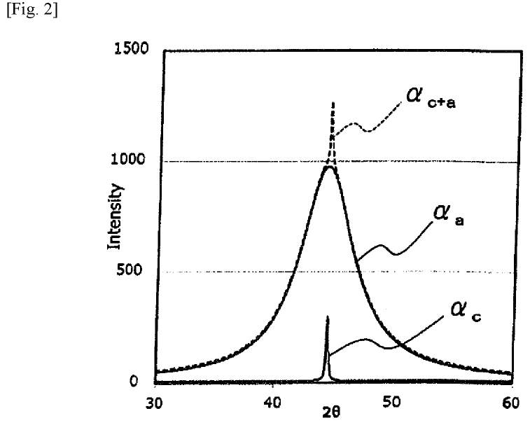

The X-ray crystal structure analysis is performed by using the XRD on the soft magnetic alloy according to the present embodiment, and a chart as shown in FIG. 1 is obtained. The chart is profile-fitted using a Lorentz function represented by the following equation (2) to obtain a crystal component pattern ac showing the crystal scattering integrated intensity, an amorphous component pattern αₐ showing the amorphous scattering integrated intensity, and a combined pattern thereof α_{c+a}, as shown in FIG. 2. Based on the crystal scattering integrated intensity and the amorphous scattering integrated intensity of the obtained patterns, the amorphization rate X is obtained according to the above equation (1). A measurement range is set to a diffraction angle 2θ=30° to 60° where amorphous-derived halos can be confirmed. Within this range, an error between the integrated intensities actually measured by using the XRD and the integrated intensities calculated using the Lorentz function can be within 1%.

$$f ( x ) = \frac{h}{1 + \frac{{( x - u )}^{2}}{{w}^{2}}} + b \qquad ( 2 )$$

h: peak height

u: peak position

w: half width

b: background height

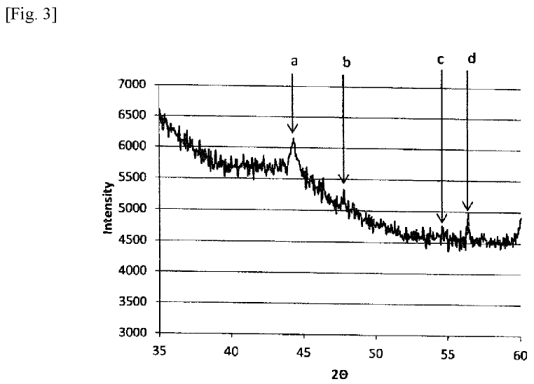

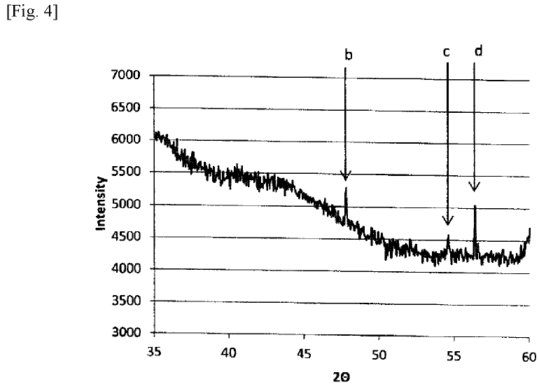

When the soft magnetic alloy according to the present embodiment is a thin film to be described later, charts as shown in FIGS. 3 and 4 are obtained by the X-ray crystal structure analysis of the thin film. By analyzing the charts shown in FIGS. 3 and 4 by software, it is possible to confirm whether the thin film has a structure including an amorphous material or a structure including a crystal. FIG. 3 is a chart in a case where the thin film has a structure including a crystal, and FIG. 4 is a chart in a case where the thin film has a structure including an amorphous material. Further, a crystal grain size of the crystal included in the thin film can also be confirmed at the same time. A peak a in FIG. 3 is a peak derived from a crystal. Peaks b to d in FIGS. 3 and 4 are peaks derived from a substrate.

In addition, the reason why the above equation (1) is not used is that it is difficult to accurately calculate the amorphization rate X in the thin film. The reason why it is difficult to accurately calculate the amorphization rate X in the thin film is that, when the X-ray crystal structure analysis is performed on the thin film, it is difficult to perform the X-ray crystal structure analysis only on the thin film, and the thin film and the substrate are both subjected to the X-ray crystal structure analysis. When the X-ray crystal structure analysis is performed on both the thin film and the substrate, the result is greatly affected by the substrate. As a result, an S/N ratio of the obtained charts becomes small.

Hereinafter, each component of the soft magnetic alloy according to the present embodiment will be described in detail.

M represents at least one selected from the group consisting of Ta, V, Zr, Hf, Ti, Nb, Mo, and W. M is preferably one or more selected from Ta, V, Zr, Hf and W, and more preferably one or more selected from Ta, V, and W.

An M amount (a) satisfies 0≤a≤0.140. That is, the soft magnetic alloy may not contain M. The M amount (a) may be 0.040≤a≤0.140, may be 0.050≤a≤0.140, or may be 0.070≤a≤0.120. Regardless of whether the M amount (a) is large or small, the coercivity Hc tends to be large. When the M amount (a) is large, the coercivity Hc tends to be large, and the saturation magnetic flux density Bs also tends to be small.

A C amount (b) satisfies 0.005≤b≤0.200. Further, the C amount (b) may be 0.020≤b≤0.150, or may be 0.040≤b≤0.080. When the C amount (b) is small, the coercivity Hc tends to be large. When the C amount (b) is large, the saturation magnetic flux density Bs tends to be low, and the coercivity Hc tends to be large.

X3 represents at least one selected from the group consisting of P, B, Si, and Ge.

An X3 amount (c) satisfies 0<c≤0.180. The X3 amount (c) may be 0.002≤c≤0.180, may be 0.005≤c≤0.180, or may be 0.005≤c≤0.100. When the X3 amount (c) is small, an amorphous material formability tends to decrease, and the coercivity Hc tends to increase. When the X3 amount (c) is large, the saturation magnetic flux density Bs tends to be low, and the coercivity Hc tends to be large.

In addition, in the soft magnetic alloy according to the present embodiment, a ratio of the C amount to the total of the C amount and the X3 amount, that is, b/(b+c) is within a predetermined range. Specifically, 0.300≤b/(b+c)<1.000. The predetermined range may be 0.308≤b/(b+c)<0.976. By controlling b/(b+c) within the above range, the amorphous material formability is increased. The saturation magnetic flux density Bs becomes high and the coercivity Hc becomes low. Even if the C amount (b) and the X3 amount (c) are within the above range, the amorphous material formability becomes low when b/(b+c) is too small. In this case, the saturation magnetic flux density Bs tends to be low, and the coercivity Hc tends to be high.

Further, b≥c may be satisfied. That is, 0.500≤b/(b+c)<1.000 may be satisfied. When b≥c, the amorphous material formability is increased. In this case, the saturation magnetic flux density Bs becomes high and the coercivity Hc becomes low.

An Fe amount (1−(a+b+c)) is not particularly limited. 0.650≤(1−(a+b+c))≤0.930 may be satisfied, or 0.650≤(1−(a+b+c))≤0.920 may be satisfied. In addition, 0.730≤1−(a+b+c)≤0.930 may be satisfied, and 0.730≤1−(a+b+c)<0.920 may be satisfied. By setting the Fe amount (1−(a+b+c)) within the above range, the amorphous material formability of the soft magnetic alloy is increased, and crystals having a crystal grain size larger than 30 nm are less likely to be formed during production of the soft magnetic alloy.

Further, in the soft magnetic alloy according to the present embodiment, a part of Fe may be substituted with X1 and/or X2.

X1 is one or more selected from the group consisting of Co and Ni. When X1 is Ni, it has an effect of lowering the coercivity Hc, and when X1 is Co, it has an effect of improving the saturation magnetic flux density Bs after the heat treatment. The type of X1 can be appropriately selected. α=0 may be used. That is, X1 may not be contained. Further, the number of atoms of X1 is 40 at % or less, with respect to a total number of atoms of 100 at % in the composition. That is, the X1 amount satisfies 0≤α{1−(a+b+c)}≤0.400. The X1 amount may satisfy 0≤α{1−(a+b+c)}≤0.100. If the number of atoms of X1 is too large, a magnetostriction increases and the coercivity Hc increases.

X2 represents at least one selected from the group consisting of Al, Mn, Ag, Zn, Sn, As, Sb, Cu, Cr, Bi, N, O, S, and rare earth elements. Further, when the soft magnetic alloy contains X2, an amount of X2 may satisfy β=0. That is, X2 may not be contained. Further, the number of atoms of X2 is preferably 3.0 at % or less, with respect to the total number of atoms of 100 at % in the composition. That is, the X2 amount preferably satisfies 0≤β{1−(a+b+c)}≤0.030.

A range of a substitution amount for substituting Fe with X1 and/or X2 is half or less of Fe on the basis of the number of atoms. That is, 0≤α+β≤0.50. When α+β>0.50, it is difficult to obtain the soft magnetic alloy having the structure including the Fe based nanocrystal by the heat treatment.

The soft magnetic alloy according to the present embodiment may contain elements other than the above elements as inevitable impurities. For example, the inevitable impurities may be contained in an amount of 0.1 wt % or less with respect to 100 wt % of the soft magnetic alloy.

The shape of the soft magnetic alloy according to the present embodiment is not particularly limited. For example, a ribbon shape, a shape in a powder form, and a thin film shape can be mentioned.

In general, the soft magnetic alloy having a thin film shape and the soft magnetic alloy having a ribbon shape or the soft magnetic alloy having a shape in a powder form have different amorphous material formabilities even if they have the same composition, and thus have different preferable compositions. Note that, in the following description, the soft magnetic alloy having the ribbon shape and the soft magnetic alloy having the shape in the powder form may be collectively referred to as bulk. Further, the soft magnetic alloy having the thin film shape may be abbreviated as a soft magnetic alloy thin film or thin film, the soft magnetic alloy having the ribbon shape may be abbreviated as a soft magnetic alloy ribbon or ribbon, and the soft magnetic alloy having the shape in the powder form may be abbreviated as a soft magnetic alloy powder or powder.

The present inventors have found that by controlling production conditions of the soft magnetic alloy thin film, the amorphous material formability of the bulk and the amorphous material formability of the soft magnetic alloy thin film can be the same or substantially the same with each other when the bulk and the soft magnetic alloy have the same composition to each other. Then, it has been found that when the amorphous material formability of the bulk and the amorphous material formability of the soft magnetic alloy thin film are the same or substantially the same with each other, a preferable composition of the bulk can be determined by determining a preferable composition of the soft magnetic alloy thin film.

Whether the amorphous material formabilities are the same or substantially the same with each other can be confirmed by the following method.

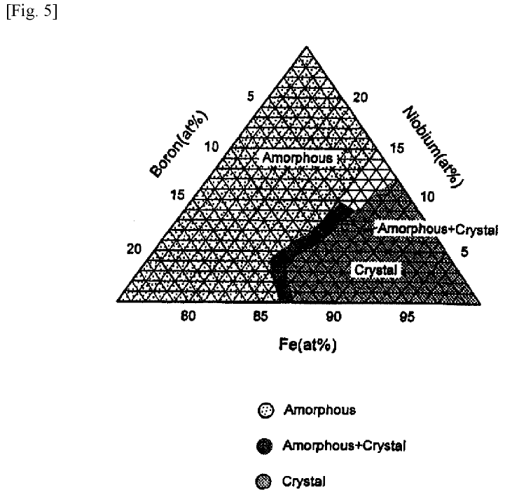

First, a known composition dependence of a crystal state of a bulk is prepared. The known composition dependence of the crystal state of the bulk may be, for example, a composition dependence of a crystal state of a bulk described in a literature, or a composition dependence of a crystal state of a bulk prepared in the past. Examples of the known composition dependence of the crystal state of the bulk include a composition dependence of a crystal state of a Fe—Nb—B system ternary bulk shown in FIG. 5.

Next, with respect to compositions shown in the composition dependence of the crystal state of the bulk, thin films are formed by a thin film method of changing temperature of the substrate at a time of film formation. By changing the temperature of the substrate during the film formation, a cooling rate at the time of film formation changes, and the crystal state of the finally obtained thin film changes. That is, the amorphous material formability of the thin film changes.

The type of thin film methods is not limited. For example, a thin film can be formed by a sputtering method or a deposition method. Hereinafter, a case where a thin film is formed by the sputtering method is described.

A film may be formed simultaneously by multi-sputtering using a plurality of types of targets, or may be formed by unit sputtering while appropriately changing targets. It is preferable to perform film formation simultaneously by multi-sputtering because it is easy to prepare a thin film having any composition in which a crystal state of a bulk is indicated by a composition dependency of the crystal state of the bulk.

The temperature of the substrate at the time of film formation is not limited, but is set to a temperature higher than the temperature of the substrate in a normal sputtering method. That is, the cooling rate is set to be lower than that of the normal sputtering method. For example, the temperature is changed in a range of about 200° C. to 300° C. This is because the composition dependence of the crystal state of the bulk and the composition dependence of the crystal state of the thin film are often the same or substantially the same between 200° C. to 300° C. However, the thin film may be formed at a temperature of a substrate outside the above range.

The type of substrates is not limited. For example, a thermally oxidized silicon substrate, a silicon substrate, a glass substrate, and a ceramic substrate can be used. Examples of the ceramic substrate include a barium titanate substrate and an ALTIC substrate. In addition, the substrate may be washed appropriately before performing sputtering.

The thickness of the thin film is not limited. For example, the thickness of the thin film may be 50 nm to 200 nm.

Next, a crystal state of the obtained thin film is evaluated.

A method for evaluating a crystal state of a thin film is not particularly limited. For example, the method can be performed by analyzing a chart obtained by using XRD with software. When a peak indicating the crystal is included in the chart, and a crystal grain size is 10 nm or less as results of analysis by software, it is considered that the thin film has a nano-heterostructure. In addition, the higher the height of the peak indicating the crystal, the more likely it is to crystallize and the lower the amorphous material formability. When comparing the amorphous material formabilities of different thin films by the height of the peak indicating the crystal, it is necessary that the different thin films have the same crystal.

Then, the obtained results are plotted on the composition dependence of the crystal state of the bulk for each temperature of the substrate. The amorphous material formability of the thin film prepared at the temperature of the substrate when the crystal states of the plurality of thin films match or substantially match with the crystal state of the bulk indicated by the composition dependency of the crystal state of the bulk matches or substantially matches with the amorphous material formability of the bulk.

The amorphous material formability of the thin film prepared at the above temperature of the substrate and the amorphous material formability of the bulk are the same or substantially the same even if the compositions change. That is, it can be concluded that the crystal state of the obtained thin film is the crystal state of the bulk when a bulk having the same composition as the obtained thin film is produced. Then, by examining a suitable composition of the thin film, a suitable composition of the bulk can be examined. In addition, it can be confirmed that the amorphous material formability of the thin film and the amorphous material formability of the bulk are the same or substantially the same by the fact that the saturation magnetic flux density Bs of the thin film and the saturation magnetic flux density Bs of the bulk are the same or substantially the same with each other.

Here, since the suitable composition of the bulk can be determined by determining the suitable composition of the thin film, it becomes easy to examine the bulk of an unknown composition.

For example, when a plurality of levels of ribbons, which are a type of the bulk, are prepared, it is necessary to repeat all the manufacturing processes every time. In addition, as shown in Table A below, it takes about 5 hours to produce one type of ribbon.

TABLE A

| Process | Content of each process | Time |
|---|---|---|
| Formulation of material | Weigh and mix each material | 1 hr |
| Preparation of base alloy | Feed material | 0.5 hr |
| | Vacuum-evacuate | 0.5 hr |
| | Heat and Melt | 0.5 hr |
| | Cool and Extract | 0.5 hr |
| | Pulverize | 0.2 hr |
| Preparation of ribbon | Feed base alloy | 0.2 hr |
| | Vacuum-evacuate | 1 hr |
| | Heat and Inject | 0.1 hr |
| | Cool and Extract | 0.5 hr |

| | |
|---|---|
| Sum | 5 hr |

With respect to this, when a plurality of levels of thin films are produced, the plurality of levels of thin films can be collectively performed with respect to a film formation preparation step and an extraction step. For example, when four types of thin films are produced as shown in Table B below, the film formation preparation step and the extraction step can be combined at one time. Then, it takes about 5.2 hours to prepare the four types of thin films. That is, it can be said that it is quicker and easier to produce a thin film than to produce a bulk. The thin film can be produced substantially four times faster than the bulk production.

TABLE B

| Process | Content of each process | Time |
|---|---|---|
| Film formation preparation | Set substrate | 0.25 hr |
| | Vacuum-evacuate | 0.25 hr |
| Film formation 1 | Transport | 0.1 hr |
| | Heat | 0.4 hr |
| | Film formation | 0.1 hr |
| | Cool | 0.5 hr |
| Film formation 2 | Transport | 0.1 hr |
| | Heat | 0.4 hr |
| | Film formation | 0.1 hr |
| | Cool | 0.5 hr |
| Film formation 3 | Transport | 0.1 hr |
| | Heat | 0.4 hr |
| | Film formation | 0.1 hr |
| | Cool | 0.5 hr |
| Film formation 4 | Transport | 0.1 hr |
| | Heat | 0.4 hr |
| | Film formation | 0.1 hr |
| | Cool | 0.5 hr |
| Extraction | Extract | 0.3 hr |

| | |
|---|---|
| Sum | 5.2 hr |

Therefore, the suitable composition of the bulk can be determined by determining the suitable composition of the thin film, so that the suitable composition of the bulk can be easily determined in a short time.

Further, when forming the thin film, the cooling rate of the thin film can be significantly changed by controlling the temperature of the substrate during sputtering or vapor deposition. In particular, when preparing the bulk, it may require achieving a cooling rate that is difficult to implement. Even for a composition for which it was difficult to evaluate the composition dependence of the crystal state because it is difficult to increase the cooling rate in the related-art bulk examination method, it is easy to evaluate the composition dependence of the crystal state in a thin film examination method. As a result, the suitable composition of the bulk can be determined by determining the suitable composition of the thin film even for a composition for which it is difficult to determine the suitable composition by the related-art bulk examination method. Therefore, by using the thin film examination method, it has become possible to find that the soft magnetic alloy having the above composition has the high saturation magnetic flux density Bs and the low coercivity Hc.

Hereinafter, a method for producing a soft magnetic alloy according to the present embodiment will be described, but the method for producing the soft magnetic alloy according to the present embodiment is not limited to the following methods.

As an example of a method for producing a soft magnetic alloy ribbon according to the present embodiment, there is a method for producing a soft magnetic alloy ribbon by a single-roll method. Moreover, the ribbon may be a continuous ribbon.

In the single-roll method, first, pure metals of metal elements contained in the soft magnetic alloy ribbon to be finally obtained are prepared, and weighed so as to have the same composition as the soft magnetic alloy ribbon to be finally obtained. Then, the pure metals of the metal elements are melted and mixed to prepare a base alloy. A method for melting the pure metals is optional, but for example, there is a method for melting the pure metals by high frequency heating after vacuum-evacuating the pure metals in a chamber. The base alloy and the soft magnetic alloy ribbon to be finally obtained usually have the same composition.

Next, the prepared base alloy is heated and melted to obtain a molten metal. A temperature of the molten metal is not particularly limited, but can be, for example, 1200° C. to 1500° C.

In the present embodiment, a temperature of a roll is not particularly limited. For example, the temperature may be room temperature to 90° C. In addition, a differential pressure between the inside of the chamber and the inside of an injection nozzle (injection pressure) is not particularly limited. For example, the differential pressure may be 20 kPa to 80 kPa.

In the single-roll method, a thickness of the obtained ribbon can be adjusted mainly by adjusting a rotation speed of the roll. However, for example, the thickness of the obtained ribbon can also be adjusted by adjusting a distance between the nozzle and the roll, the temperature of the molten metal, and the like. The thickness of the ribbon is not particularly limited, but can be, for example, 10 μm to 80 μm.

The soft magnetic alloy ribbon before heat treatment, which will be described later, does not contain a crystal having a particle size larger than 30 nm. The soft magnetic alloy ribbon before the heat treatment may have a structure including only an amorphous material, or may have a nano-heterostructure in which microcrystals are present in the amorphous material.

In addition, a method for confirming whether or not a ribbon contains crystals having a particle size larger than 30 nm is not particularly limited. For example, the presence or absence of the crystals having the particle size larger than 30 nm can be confirmed by ordinary X-ray diffraction measurement.

In addition, a method for observing the presence or absence of microcrystals and the average particle size is not particularly limited; however, for example, it can be confirmed by obtaining a selected area electron diffraction image, a nanobeam diffraction image, a bright-field image, or a high-resolution image using a transmission electron microscope with respect to a sample thinned by ion milling. When the selected area electron diffraction image or the nanobeam diffraction image are used, a ring-shaped diffraction is formed when a diffraction pattern is amorphous, whereas a diffraction spot due to a crystal structure is formed when the diffraction pattern is not amorphous. In addition, when the bright-field image or the high-resolution image is used, the presence or absence of initial microcrystals and the average particle size can be observed by visual observation at a magnification of 1.00×10⁵ to 3.00×10⁵.

Hereinafter, a method for producing a soft magnetic alloy ribbon having a structure including Fe based nanocrystals by heat-treating the soft magnetic alloy ribbon will be described. In addition, in the present embodiment, the structure including the Fe based nanocrystals is a structure including crystals having an amorphization rate X of less than 85%. As described above, the amorphization rate X can be measured by performing X-ray crystal structure analysis by XRD.

Heat treatment conditions for producing the soft magnetic alloy ribbon of the present embodiment are not particularly limited. Preferred heat treatment conditions differ depending on the composition of the soft magnetic ribbon. Generally, a preferable heat treatment temperature is about 450° C. to 650° C., and a preferable heat treatment time is about 0.5 to 10 hours. However, depending on the composition, there may be a preferable heat treatment temperature and heat treatment time outside the above ranges. Further, an atmosphere at the time of heat treatment is not particularly limited. The method may be carried out in an active atmosphere such as in the air, in an inert atmosphere such as in Ar gas, or in a vacuum.

In addition, a method for calculating an average particle size of Fe based nanocrystals contained in a soft magnetic alloy ribbon obtained by heat treatment is not particularly limited. For example, the average particle size can be calculated by observing with a transmission electron microscope. Further, a method for confirming that a crystal structure is bcc (body-centered cubic lattice structure) is not particularly limited. For example, it can be confirmed using the X-ray diffraction measurement.

As an example of a method for producing a soft magnetic alloy powder according to the present embodiment, there is a method for producing a soft magnetic alloy powder by a gas atomization method.

In the gas atomization method, first, pure metals of metal elements contained in a soft magnetic alloy to be finally obtained are prepared, and weighed so as to have the same composition as the soft magnetic alloy to be finally obtained. Then, the pure metals of the metal elements are melted and mixed to prepare a base alloy. The method for melting the pure metals is not particularly limited, but for example, there is the method for melting the pure metals by the high frequency heating after vacuum-evacuating the pure metals in the chamber. The base alloy and the soft magnetic alloy to be finally obtained usually have the same composition.

Next, the prepared base alloy is heated and melted to obtain a molten metal. A temperature of the molten metal is not particularly limited, but can be, for example, 1200° C. to 1500° C. Thereafter, the molten alloy is injected with a gas atomizing equipment to produce a powder.

By controlling injection conditions at this time, the particle size of the soft magnetic alloy powder can be preferably controlled.

The particle size of the soft magnetic alloy powder is not particularly limited. For example, D50 is 1 μm to 150 μm. In addition, when the soft magnetic alloy powder has a structure including Fe based nanocrystals, one particle of the soft magnetic alloy powder usually contains a large number of Fe based nanocrystals. Therefore, the particle size of the soft magnetic alloy powder and the crystal grain size of the Fe based nanocrystals are different.

Suitable injection conditions vary depending on composition of the molten metal and a target particle size, but are, for example, a nozzle diameter of 0.5 mm to 3 mm, a molten metal discharge amount of 1.5 kg/min or less, and a gas pressure of 5 MPa to 10 MPa.

By the above method, the soft magnetic alloy powder before heat treatment can be obtained. In order to preferably control the particle size, it is preferable that the soft magnetic alloy powder at this time has a structure including an amorphous material.

In order to preferably obtain the soft magnetic alloy powder having the structure including the Fe based nanocrystals, it is preferable to perform heat treatment on the soft magnetic alloy powder having the structure including the amorphous material obtained by the above gas atomization method. For example, by performing the heat treatment at 300° C. to 650° C. for 0.5 to 10 hours, a soft magnetic alloy powder having a structure preferably including Fe based nanocrystals can be easily obtained. Then, a soft magnetic alloy powder having a high saturation magnetic flux density Bs and a low coercivity Hc can be obtained.

As an example of a method for producing a soft magnetic alloy thin film according to the present embodiment, there is the method for producing the soft magnetic alloy thin film by the sputtering method as described above.

An application of the soft magnetic alloy according to the present embodiment is not particularly limited. For example, in the case of the soft magnetic alloy ribbon, a core, an inductor, a transformer, a motor and the like can be mentioned. In the case of soft magnetic alloy powder, a powder magnetic core can be mentioned. In particular, the powder magnetic core can be suitably used as a powder magnetic core for an inductor, particularly a power inductor. In addition, the soft magnetic alloy can also be suitably used for a magnetic component using a soft magnetic alloy thin film, for example, a thin film inductor and a magnetic head.

The soft magnetic alloy according to the present embodiment can be, for example, a soft magnetic alloy having a higher saturation magnetic flux density Bs than a well-known Fe—Si—B—Nb—Cu based soft magnetic alloy. In addition, the soft magnetic alloy according to the present embodiment can be a soft magnetic alloy having a coercivity Hc lower than that of an Fe—Nb—B based soft magnetic alloy, which is known to have a higher saturation magnetic flux density Bs than that of the Fe—Si—B—Nb—Cu based soft magnetic alloy. Furthermore, the soft magnetic alloy according to the present embodiment can easily have a saturation magnetic flux density Bs higher than that of the Fe—Nb—B based soft magnetic alloy. That is, the magnetic component using the soft magnetic alloy according to the present embodiment can easily achieve improvement in soft magnetic properties, reduction in core loss, and improvement in permeability. That is, by using the soft magnetic alloy according to the present embodiment, a magnetic component having lower power consumption and higher efficiency can be obtained more easily than in the case of using the well-known Fe—Si—B—Nb—Cu based soft magnetic alloy or Fe—Nb—B based soft magnetic alloy. Furthermore, when the soft magnetic alloy according to the present embodiment is used in a power supply circuit, it is easy to achieve a reduction in energy loss and an improvement in power supply efficiency.

### EXAMPLES

Hereinafter, the present invention will be described based on more detailed examples, but the present invention is not limited to these examples.

(Determination on Temperature of Substrate during Formation of Thin Film) First, as a known composition dependence of a crystal state of a bulk, a composition dependence of a crystal state of a bulk of a Fe—Nb—B based ternary system shown in FIG. 5 was prepared.

Next, regarding compositions in which the crystal state of the bulk is indicated by the composition dependence of the crystal state of the bulk, thin films were prepared by a sputtering method by changing the temperature of the substrate during film formation.

The film formation was performed using magnetron sputtering system (ES340 manufactured by Eiko Co., Ltd.). In addition, the film formation was performed simultaneously by multiple-sputtering using a plurality of types of targets.

In the present example, the thin films formed of Fe, Nb, and B were prepared by setting the temperature of the substrate to 474K (201° C.), 523K (250° C.), or 575K (302° C.). In addition, the substrate was obtained by cutting the thermally oxidized silicon substrate into a size of 6 mm×6 mm and performing ultrasonic cleaning using a solvent in an order of water, acetone, and IPA. The film thickness was 100 nm. A gas flow rate in a chamber was 20 sccm, and a gas pressure in the chamber was 0.4 Pa.

Next, crystal states of the thin films obtained using XRD were evaluated. The crystal states of the obtained thin films were plotted for each temperature of the substrate in terms of the composition dependence of the crystal state of the bulk. As a result, when the temperature of the substrate was 250° C., the crystal states of the thin films became the same as the crystal states indicated by the composition dependence of the crystal state of the bulk.

### Experimental Example 1

Soft magnetic alloys each having a composition shown in Table 1 were prepared. For each composition, both a ribbon shape soft magnetic alloy and a thin film shape soft magnetic alloy were prepared. In addition, the compositions shown in Table 1 are a well-known Fe—Si—B—Nb—Cu based soft magnetic alloy composition and a well-known Fe—Nb—B based soft magnetic alloy composition.

Hereinafter, a method for producing a ribbon shape soft magnetic alloy will be described. First, pure metal materials were weighed so as to obtain a base alloy having the composition shown in Table 1. Then, the pure metal materials were vacuum-evacuated in a chamber and then melted by high frequency heating to prepare the base alloy.

Thereafter, the prepared base alloy was heated and melted to form a metal in a molten state at 1200° C., and then the metal was injected onto a roll by a single-roll method at a rotation speed of 15 m/sec. to prepare a ribbon. A material of the roll was Cu. A roll temperature was 25° C., and a differential pressure between the chamber and an injection nozzle (injection pressure) was 40 kPa. In addition, by setting a slit width of a slit nozzle to 180 mm, a distance from a slit opening portion to the roll to 0.2 mm, and a diameter (p of the roll to 300 mm, the thickness of the obtained ribbon was 20 m, the width of the ribbon was 5 mm, and the length of the ribbon was several tens of meters.

Next, the ribbon was to be heat-treated, but before that, it was confirmed whether the ribbon before the heat treatment included an amorphous material or a crystal. The amorphization rate X of each ribbon was measured using XRD, and when X was 85% or more, it was confirmed that the ribbon before the heat treatment included the amorphous material. When X was less than 85%, it was confirmed that the ribbon before the heat treatment included the crystal. Results are shown in Table 1. Furthermore, the presence or absence of microcrystals was confirmed by observing a selected area diffraction image and a bright field image at 300,000 times using a transmission electron microscope. As a result, it was confirmed that each ribbon in Table 1 had no microcrystals.

In addition, it was confirmed that all the ribbons of the examples and the comparative examples described below did not have microcrystals before the heat treatment unless otherwise specified.

Next, each of the prepared ribbons was heat-treated at temperatures shown in Table 1 for 60 minutes. The atmosphere during the heat treatment was in an inert atmosphere (Ar atmosphere).

A coercivity Hc and a saturation magnetic flux density Bs of each ribbon after the heat treatment were measured. The coercivity Hc was measured using an He meter. The saturation magnetic flux density Bs was measured with a vibrating sample magnetometer (VSM) at a maximum applied magnetic field of 1,000 Oe.

In addition, in the ribbons of the examples and the comparative examples described below, unless otherwise specified, it was confirmed by X-ray diffraction measurement and observation using the transmission electron microscope that all the ribbons had Fe based nanocrystals having an average particle size of 5 nm to 30 nm and a crystal structure of bcc. In addition, it was confirmed by ICP analysis that there was no change in alloy compositions before and after the heat treatment.

Hereinafter, a method for producing a soft magnetic alloy in the thin film shape will be described.

The formation of the thin film was performed by the same method as in the determination of the temperature of the substrate at the time of thin film formation. The temperature of the substrate was set to 250° C. as described above.

Next, the thin film was to be heat-treated, but before that, it was confirmed whether the thin film before the heat treatment included an amorphous material or a crystal. Charts as shown in FIGS. 3 and 4 were prepared for each thin film by using XRD. Then, the obtained charts were analyzed using software (Panalytical; High score), and it was confirmed whether the thin film before the heat treatment included the amorphous material or the crystal. The results are shown in Table 1. FIG. 3 shows an example of a case where the thin film includes the crystal, and FIG. 4 shows an example of a case where the thin film includes the amorphous material.

Next, each of the prepared thin films was heat-treated at a temperature shown in Table 1. An atmosphere during the heat treatment was in vacuum.

A coercivity Hc and a saturation magnetic flux density Bs of each thin film after the heat treatment were measured. The coercivity Hc and the saturation magnetic flux density Bs were measured using the vibrating sample magnetometer (VSM) at the maximum applied magnetic field of 1,000 Oe.

In addition, in the thin films of the examples and the comparative examples described below, unless otherwise specified, it was confirmed by the X-ray diffraction measurement and the observation using the transmission electron microscope that all the thin films had Fe based nanocrystals having an average particle size of 5 nm to 30 nm and a crystal structure of bcc. In addition, it was confirmed by the ICP analysis that there was no change in alloy compositions before and after the heat treatment.

TABLE 1

| | Example/ | | | Heat | | | Hc | Hc |
|---|---|---|---|---|---|---|---|---|
| Sample | Comparative | | | treatment | | Bs | (ribbon) | (thin film) |
| Number | Example | Composition | Shape | temperature | XRD | (T) | (A/m) | (Oe) |
| 1 | Comparative | Fe_{73.5}Si_{13.5}B₉Nb₃Cu₁ | Ribbon | 600° C. | Amorphous | 1.23 | 0.7 | — |
| | Example | | | | material | | | |
| 2 | Comparative | Fe_{73.5}Si_{13.5}B₉Nb₃Cu₁ | Thin | 500° C. | Amorphous | 1.26 | — | 2.3 |
| | Example | | film | | material | | | |
| 3 | Comparative | Fe₈₄Nb₇B₉ | Ribbon | 600° C. | Amorphous | 1.43 | 7.3 | — |
| | Example | | | | material | | | |
| 4 | Comparative | Fe₈₄Nb₇B₉ | Thin | 500° C. | Amorphous | 1.41 | — | 22.3 |
| | Example | | film | | material | | | |

From Table 1, it was confirmed that the saturation magnetic flux densities Bs of the ribbon under the heat treatment temperature of 600° C. and the saturation magnetic flux densities Bs of thin film under the heat treatment temperature of 500° C. were substantially the same with each other when the ribbon and the film have the same composition to each other. That is, from crystal states and magnetic properties of the thin film produced under production conditions of Experimental Example 1, crystal states and magnetic properties of the ribbon prepared under the production conditions of Experimental Example 1 can be known.

In addition, from test results shown in Table 1, in the thin film of the experimental example shown below, when the thin film after the film formation and before the heat treatment had a structure including the amorphous material, an amorphous property after the film formation was good. Further, magnetic properties were good when the saturation magnetic flux density Bs after the heat treatment was 1.30 T or more and the coercivity Hc was 22.0 Oe or less. In addition, in the ribbon of the experimental example shown below, when the amorphization rate X before the heat treatment was 85% or more, an amorphous property before the heat treatment was good. Further, magnetic properties were good when the saturation magnetic flux density Bs after the heat treatment was 1.30 T or more and the coercivity Hc was 7.0 A/m or less.

(Experimental Example 2) In Experimental Example 2, thin films whose compositions and heat treatment temperatures were changed under the production conditions of Experimental Example 1 were prepared. Results are shown in Tables 2 to 8 and Tables 9A to 9E.

TABLE 2

| | | Fe_{(1 - (a + b + c))}MₐC_{b}X3_{c}(α = β = 0) | | | | | | | |
|---|---|---|---|---|---|---|---|---|---|
| | Example/ | | | | | | | | Hc |
| Sample | Comparative | | M = Ta | C | X3 = P | b/ | | Bs | (thin film) |
| Number | Example | Fe | a | b | c | (b + c) | XRD | (T) | (Oe) |
| 5 | Example | 0.920 | 0.000 | 0.060 | 0.020 | 0.750 | Amorphous | 1.75 | 21.9 |
| | | | | | | | material | | |
| 6 | Example | 0.900 | 0.020 | 0.060 | 0.020 | 0.750 | Amorphous | 1.78 | 17.1 |
| | | | | | | | material | | |
| 7 | Example | 0.880 | 0.040 | 0.060 | 0.020 | 0.750 | Amorphous | 1.80 | 13.9 |
| | | | | | | | material | | |
| 8 | Example | 0.870 | 0.050 | 0.060 | 0.020 | 0.750 | Amorphous | 1.82 | 12.1 |
| | | | | | | | material | | |
| 9 | Example | 0.850 | 0.070 | 0.060 | 0.020 | 0.750 | Amorphous | 1.84 | 8.7 |
| | | | | | | | material | | |
| 10 | Example | 0.830 | 0.090 | 0.060 | 0.020 | 0.750 | Amorphous | 1.80 | 5.6 |
| | | | | | | | material | | |
| 11 | Example | 0.820 | 0.100 | 0.060 | 0.020 | 0.750 | Amorphous | 1.78 | 5.9 |
| | | | | | | | material | | |
| 12 | Example | 0.800 | 0.120 | 0.060 | 0.020 | 0.750 | Amorphous | 1.70 | 9.0 |
| | | | | | | | material | | |
| 13 | Example | 0.780 | 0.140 | 0.060 | 0.020 | 0.750 | Amorphous | 1.58 | 14.9 |
| | | | | | | | material | | |
| 14 | Comparative | 0.760 | 0.160 | 0.060 | 0.020 | 0.750 | Amorphous | 1.39 | 36.2 |
| | Example | | | | | | material | | |

TABLE 3

| | | Fe_{(1 - (a + b + c))}MₐC_{b}X3_{c}(α = β = 0) | | | | | | | |
|---|---|---|---|---|---|---|---|---|---|
| | Example/ | | | | | | | | Hc |
| Sample | Comparative | | M = Ta | C | X3 = P | b/ | | Bs | (thin film) |
| Number | Example | Fe | a | b | c | (b + c) | XRD | (T) | (Oe) |
| 15 | Example | 0.830 | 0.090 | 0.078 | 0.002 | 0.975 | Amorphous | 1.76 | 9.4 |
| | | | | | | | material | | |
| 10 | Example | 0.830 | 0.090 | 0.060 | 0.020 | 0.750 | Amorphous | 1.80 | 5.6 |
| | | | | | | | material | | |
| 16 | Example | 0.830 | 0.090 | 0.040 | 0.040 | 0.500 | Amorphous | 1.83 | 9.8 |
| | | | | | | | material | | |
| 17 | Example | 0.830 | 0.090 | 0.030 | 0.050 | 0.375 | Amorphous | 1.82 | 14.3 |
| | | | | | | | material | | |
| 18 | Example | 0.830 | 0.090 | 0.024 | 0.056 | 0.300 | Amorphous | 1.73 | 20.8 |
| | | | | | | | material | | |
| 19 | Comparative | 0.830 | 0.090 | 0.020 | 0.060 | 0.250 | Amorphous | 1.67 | 42.9 |
| | Example | | | | | | material | | |
| 20 | Comparative | 0.830 | 0.090 | 0.010 | 0.070 | 0.125 | Amorphous | 1.53 | 120.0 |
| | Example | | | | | | material | | |
| 21 | Comparative | 0.830 | 0.090 | 0.000 | 0.080 | 0.000 | Amorphous | 1.41 | 212.6 |
| | Example | | | | | | material | | |

TABLE 4

| | | Fe_{(1 - (a + b + c))}MₐC_{b}X3_{c}(α = β = 0) | | | | | | | |
|---|---|---|---|---|---|---|---|---|---|
| | Example/ | | | | | | | | Hc |
| Sample | Comparative | | M = Ta | C | X3 = P | b/ | | Bs | (thin film) |
| Number | Example | Fe | a | b | c | (b + c) | XRD | (T) | (Oe) |
| 22 | Example | 0.865 | 0.090 | 0.040 | 0.005 | 0.889 | Amorphous | 1.79 | 9.5 |
| | | | | | | | material | | |
| 23 | Example | 0.845 | 0.090 | 0.060 | 0.005 | 0.923 | Amorphous | 1.80 | 8.4 |
| | | | | | | | material | | |
| 24 | Example | 0.825 | 0.090 | 0.080 | 0.005 | 0.941 | Amorphous | 1.79 | 8.1 |
| | | | | | | | material | | |
| 25 | Example | 0.805 | 0.090 | 0.100 | 0.005 | 0.952 | Amorphous | 1.73 | 10.7 |
| | | | | | | | material | | |
| 26 | Example | 0.755 | 0.090 | 0.150 | 0.005 | 0.968 | Amorphous | 1.62 | 14.9 |
| | | | | | | | material | | |
| 27 | Example | 0.705 | 0.090 | 0.200 | 0.005 | 0.976 | Amorphous | 1.46 | 20.7 |
| | | | | | | | material | | |
| 28 | Comparative | 0.605 | 0.090 | 0.300 | 0.005 | 0.984 | Amorphous | 0.95 | 67.0 |
| | Example | | | | | | material | | |

TABLE 5

| | | Fe_{(1 - (a + b + c))}MₐC_{b}X3_{c}(α = β = 0) | | | | | | | |
|---|---|---|---|---|---|---|---|---|---|
| | Example/ | | | | | | | | Hc |
| Sample | Comparative | | M = Ta | C | X3 = P | b/ | | Bs | (thin film) |
| Number | Example | Fe | a | b | c | (b + c) | XRD | (T) | (Oe) |
| 29 | Comparative | 0.854 | 0.140 | 0.001 | 0.005 | 0.167 | Amorphous | 1.43 | 37.6 |
| | Example | | | | | | material | | |
| 30 | Example | 0.850 | 0.140 | 0.005 | 0.005 | 0.500 | Amorphous | 1.47 | 21.8 |
| | | | | | | | material | | |
| 31 | Example | 0.845 | 0.140 | 0.010 | 0.005 | 0.667 | Amorphous | 1.49 | 20.1 |
| | | | | | | | material | | |
| 32 | Example | 0.835 | 0.140 | 0.020 | 0.005 | 0.800 | Amorphous | 1.51 | 16.4 |
| | | | | | | | material | | |
| 33 | Example | 0.815 | 0.140 | 0.040 | 0.005 | 0.889 | Amorphous | 1.53 | 15.7 |
| | | | | | | | material | | |
| 34 | Example | 0.795 | 0.140 | 0.060 | 0.005 | 0.923 | Amorphous | 1.55 | 15.3 |
| | | | | | | | material | | |

TABLE 6

| | | Fe_{(1 - (a + b + c))}MₐC_{b}X3_{c}(α = β = 0) | | | | | | | |
|---|---|---|---|---|---|---|---|---|---|
| | Example/ | | | | | | | | Hc |
| Sample | Comparative | | M = Ta | C | X3 = P | b/ | | Bs | (thin film) |
| Number | Example | Fe | a | b | c | (b + c) | XRD | (T) | (Oe) |
| 35 | Example | 0.780 | 0.090 | 0.080 | 0.050 | 0.615 | Amorphous | 1.59 | 5.9 |
| | | | | | | | material | | |
| 36 | Example | 0.730 | 0.090 | 0.080 | 0.100 | 0.444 | Amorphous | 1.52 | 7.4 |
| | | | | | | | material | | |
| 37 | Example | 0.680 | 0.090 | 0.080 | 0.150 | 0.348 | Amorphous | 1.45 | 10.8 |
| | | | | | | | material | | |
| 38 | Example | 0.650 | 0.090 | 0.080 | 0.180 | 0.308 | Amorphous | 1.32 | 20.4 |
| | | | | | | | material | | |
| 39 | Comparative | 0.630 | 0.090 | 0.080 | 0.200 | 0.286 | Amorphous | 1.21 | 75.2 |
| | Example | | | | | | material | | |

TABLE 7

| | | Fe_{(1 - (a + b + c))}MₐC_{b}X3_{c}(α = β = 0) | | | | | | | | |
|---|---|---|---|---|---|---|---|---|---|---|
| | Example/ | | | | | | | | | Hc |
| Sample | Comparative | | M = Ta | C | X3 | | b/ | | Bs | (thin film) |
| Number | Example | Fe | a | b | c | Type | (b + c) | XRD | (T) | (Oe) |
| 8 | Example | 0.870 | 0.050 | 0.060 | 0.020 | P | 0.750 | Amorphous | 1.82 | 12.1 |
| | | | | | | | | material | | |
| 9 | Example | 0.850 | 0.070 | 0.060 | 0.020 | P | 0.750 | Amorphous | 1.84 | 8.7 |
| | | | | | | | | material | | |
| 10 | Example | 0.830 | 0.090 | 0.060 | 0.020 | P | 0.750 | Amorphous | 1.80 | 5.6 |
| | | | | | | | | material | | |
| 40 | Example | 0.870 | 0.050 | 0.040 | 0.040 | P | 0.500 | Amorphous | 1.84 | 19.4 |
| | | | | | | | | material | | |
| 41 | Example | 0.850 | 0.070 | 0.040 | 0.040 | P | 0.500 | Amorphous | 1.84 | 15.7 |
| | | | | | | | | material | | |
| 16 | Example | 0.830 | 0.090 | 0.040 | 0.040 | P | 0.500 | Amorphous | 1.83 | 9.8 |
| | | | | | | | | material | | |
| 42 | Example | 0.870 | 0.050 | 0.060 | 0.020 | B | 0.750 | Amorphous | 1.79 | 13.6 |
| | | | | | | | | material | | |
| 43 | Example | 0.850 | 0.070 | 0.060 | 0.020 | B | 0.750 | Amorphous | 1.67 | 3.5 |
| | | | | | | | | material | | |
| 44 | Example | 0.830 | 0.090 | 0.060 | 0.020 | B | 0.750 | Amorphous | 1.52 | 6.9 |
| | | | | | | | | material | | |
| 45 | Example | 0.870 | 0.050 | 0.040 | 0.040 | B | 0.500 | Amorphous | 1.80 | 20.7 |
| | | | | | | | | material | | |
| 46 | Example | 0.850 | 0.070 | 0.040 | 0.040 | B | 0.500 | Amorphous | 1.69 | 3.8 |
| | | | | | | | | material | | |
| 47 | Example | 0.830 | 0.090 | 0.040 | 0.040 | B | 0.500 | Amorphous | 1.50 | 9.1 |
| | | | | | | | | material | | |
| 48 | Example | 0.830 | 0.070 | 0.040 | 0.060 | B | 0.400 | Amorphous | 1.62 | 7.8 |
| | | | | | | | | material | | |
| 49 | Example | 0.810 | 0.070 | 0.040 | 0.080 | B | 0.333 | Amorphous | 1.54 | 9.4 |
| | | | | | | | | material | | |
| 50 | Example | 0.850 | 0.070 | 0.060 | 0.020 | Si | 0.750 | Amorphous | 1.69 | 5.7 |
| | | | | | | | | material | | |
| 51 | Example | 0.850 | 0.070 | 0.040 | 0.040 | Si | 0.500 | Amorphous | 1.73 | 6.2 |
| | | | | | | | | material | | |
| 52 | Example | 0.830 | 0.070 | 0.040 | 0.060 | Si | 0.400 | Amorphous | 1.65 | 10.8 |
| | | | | | | | | material | | |
| 53 | Example | 0.810 | 0.070 | 0.040 | 0.080 | Si | 0.333 | Amorphous | 1.55 | 13.5 |
| | | | | | | | | material | | |
| 54 | Example | 0.850 | 0.070 | 0.040 | 0.040 | Ge | 0.500 | Amorphous | 1.61 | 12.8 |
| | | | | | | | | material | | |

TABLE 8

| | | Fe_{(1 - (a + b + c))}MₐC_{b}X3_{c}(α = β = 0) | | | | | | | | |
|---|---|---|---|---|---|---|---|---|---|---|
| | Example/ | | | | | | | | | Hc |
| Sample | Comparative | | M | | C | X3 = P | b/ | | Bs | (thin film) |
| Number | Example | Fe | Type | a | b | c | (b + c) | XRD | (T) | (Oe) |
| 10 | Example | 0.830 | Ta | 0.090 | 0.060 | 0.020 | 0.750 | Amorphous | 1.80 | 5.6 |
| | | | | | | | | material | | |
| 55 | Example | 0.830 | V | 0.090 | 0.060 | 0.020 | 0.750 | Amorphous | 1.75 | 7.1 |
| | | | | | | | | material | | |
| 56 | Example | 0.830 | W | 0.090 | 0.060 | 0.020 | 0.750 | Amorphous | 1.66 | 9.3 |
| | | | | | | | | material | | |
| 57 | Example | 0.830 | Zr | 0.090 | 0.060 | 0.020 | 0.750 | Amorphous | 1.56 | 14.8 |
| | | | | | | | | material | | |
| 58 | Example | 0.830 | Hf | 0.090 | 0.060 | 0.020 | 0.750 | Amorphous | 1.54 | 13.9 |
| | | | | | | | | material | | |
| 59 | Example | 0.830 | Ti | 0.090 | 0.060 | 0.020 | 0.750 | Amorphous | 1.57 | 17.4 |
| | | | | | | | | material | | |
| 60 | Example | 0.830 | Mo | 0.090 | 0.060 | 0.020 | 0.750 | Amorphous | 1.48 | 21.3 |
| | | | | | | | | material | | |
| 61 | Example | 0.830 | Nb | 0.090 | 0.060 | 0.020 | 0.750 | Amorphous | 1.46 | 21.2 |
| | | | | | | | | material | | |

TABLE 9A

| | | | Heat | | | | | | | | | | | |
|---|---|---|---|---|---|---|---|---|---|---|---|---|---|---|
| | | | treat- | | | | | | | | | | | |
| | | | ment | | | | | | | | | | | |
| | Example/ | | tem- | (Fe_{(1 - (α+ β))}X1_{α}X2_{β})_{(1 - (a + b + c))}MₐC_{b}X3_{c} | | | | | | | | | | |
| | Compar- | | per- | X1 | | X2 | | | | | | | | Hc |
| Sample | ative | | ature | | α{1 − | | β{1 − | M = Ta | C | X3 = P | b/ | | Bs | (thin film) |
| Number | Example | Shape | (° C.) | Type | (a + b + c)} | Type | (a + b + c)} | a | b | c | (b + c) | XRD | (T) | (Oe) |
| 10 | Example | Thin | 500 | — | 0.000 | — | 0.000 | 0.090 | 0.060 | 0.020 | 0.750 | Amorphous | 1.80 | 5.6 |
| | | film | | | | | | | | | | material | | |
| 62 | Example | Thin | 500 | Co | 0.100 | — | 0.000 | 0.090 | 0.060 | 0.020 | 0.750 | Amorphous | 1.82 | 9.4 |
| | | film | | | | | | | | | | material | | |
| 64 | Example | Thin | 500 | Ni | 0.100 | — | 0.000 | 0.090 | 0.060 | 0.020 | 0.750 | Amorphous | 1.73 | 6.2 |
| | | film | | | | | | | | | | material | | |
| 65 | Example | Thin | 500 | Ni | 0.400 | — | 0.000 | 0.090 | 0.060 | 0.020 | 0.750 | Amorphous | 1.66 | 8.7 |
| | | film | | | | | | | | | | material | | |
| 66 | Example | Thin | 500 | — | 0.000 | Al | 0.010 | 0.090 | 0.060 | 0.020 | 0.750 | Amorphous | 1.74 | 5.3 |
| | | film | | | | | | | | | | material | | |
| 66a | Example | Thin | 500 | — | 0.000 | Al | 0.030 | 0.090 | 0.060 | 0.020 | 0.750 | Amorphous | 1.59 | 11.8 |
| | | film | | | | | | | | | | material | | |
| 67 | Example | Thin | 500 | — | 0.000 | Mn | 0.010 | 0.090 | 0.060 | 0.020 | 0.750 | Amorphous | 1.69 | 12.3 |
| | | film | | | | | | | | | | material | | |
| 68 | Example | Thin | 500 | — | 0.000 | Ag | 0.010 | 0.090 | 0.060 | 0.020 | 0.750 | Amorphous | 1.77 | 6.1 |
| | | film | | | | | | | | | | material | | |
| 69 | Example | Thin | 500 | — | 0.000 | Zn | 0.010 | 0.090 | 0.060 | 0.020 | 0.750 | Amorphous | 1.71 | 6.4 |
| | | film | | | | | | | | | | material | | |
| 70 | Example | Thin | 500 | — | 0.000 | Sn | 0.010 | 0.090 | 0.060 | 0.020 | 0.750 | Amorphous | 1.73 | 9.2 |
| | | film | | | | | | | | | | material | | |
| 71 | Example | Thin | 500 | — | 0.000 | As | 0.010 | 0.090 | 0.060 | 0.020 | 0.750 | Amorphous | 1.74 | 8.5 |
| | | film | | | | | | | | | | material | | |
| 72 | Example | Thin | 500 | — | 0.000 | Sb | 0.010 | 0.090 | 0.060 | 0.020 | 0.750 | Amorphous | 1.74 | 8.1 |
| | | film | | | | | | | | | | material | | |
| 73 | Example | Thin | 500 | — | 0.000 | Cu | 0.010 | 0.090 | 0.060 | 0.020 | 0.750 | Amorphous | 1.79 | 5.4 |
| | | film | | | | | | | | | | material | | |
| 74 | Example | Thin | 500 | — | 0.000 | Cr | 0.010 | 0.090 | 0.060 | 0.020 | 0.750 | Amorphous | 1.65 | 6.8 |
| | | film | | | | | | | | | | material | | |
| 75 | Example | Thin | 500 | — | 0.000 | Bi | 0.010 | 0.090 | 0.060 | 0.020 | 0.750 | Amorphous | 1.70 | 10.2 |
| | | film | | | | | | | | | | material | | |
| 76 | Example | Thin | 500 | — | 0.000 | La | 0.010 | 0.090 | 0.060 | 0.020 | 0.750 | Amorphous | 1.57 | 9.9 |
| | | film | | | | | | | | | | material | | |
| 77 | Example | Thin | 500 | — | 0.000 | Y | 0.010 | 0.090 | 0.060 | 0.020 | 0.750 | Amorphous | 1.62 | 11.2 |
| | | film | | | | | | | | | | material | | |

TABLE 9B

| | | | Heat | | | | | | | | | | | |
|---|---|---|---|---|---|---|---|---|---|---|---|---|---|---|
| | | | treat- | | | | | | | | | | | |
| | Example/ | | ment | (Fe_{(1 - (α+ β))}X1_{α}X2_{β})_{(1 - (a + b + c))}MₐC_{b}X3_{c} | | | | | | | | | | |
| | Com- | | temper- | X1 | | X2 | | | | | | | | Hc |
| Sample | parative | | ature | | α{1 − | | β{1 − | M = Ta | C | X3 = P | b/ | | Bs | (thin film) |
| Number | Example | Shape | (° C.) | Type | (a + b + c)} | Type | (a + b + c)} | a | b | c | (b + c) | XRD | (T) | (Oe) |
| 10 | Example | Thin | 500 | — | 0.000 | — | 0.000 | 0.090 | 0.060 | 0.020 | 0.750 | Amorphous | 1.80 | 5.6 |
| | | film | | | | | | | | | | material | | |
| 62 | Example | Thin | 500 | Co | 0.100 | — | 0.000 | 0.090 | 0.060 | 0.020 | 0.750 | Amorphous | 1.82 | 9.4 |
| | | film | | | | | | | | | | material | | |
| 113 | Example | Thin | 500 | — | 0.000 | — | 0.000 | 0.090 | 0.080 | 0.020 | 0.800 | Amorphous | 1.73 | 3.5 |
| | | film | | | | | | | | | | material | | |
| 108 | Example | Thin | 500 | Co | 0.100 | — | 0.000 | 0.090 | 0.080 | 0.020 | 0.800 | Amorphous | 1.81 | 4.9 |
| | | film | | | | | | | | | | material | | |

TABLE 9C

| | | | Heat | | | | | | | | | | | |
|---|---|---|---|---|---|---|---|---|---|---|---|---|---|---|
| | | | treat- | | | | | | | | | | | |
| | Example/ | | ment | (Fe_{(1 - (α+ β))}X1_{α}X2_{β})_{(1 - (a + b + c))}MₐC_{b}X3_{c} | | | | | | | | | | |
| | Com- | | temper- | X1 | | X2 | | | | | | | | Hc |
| Sample | parative | | ature | | α{1 − | | β{1 − | M = Ta | C | X3 = P | b/ | | Bs | (thin film) |
| Number | Example | Shape | (° C.) | Type | (a + b + c)} | Type | (a + b + c)} | a | b | c | (b + c) | XRD | (T) | (Oe) |
| 108 | Example | Thin | 500 | Co | 0.100 | — | 0.000 | 0.090 | 0.080 | 0.020 | 0.800 | Amorphous | 1.81 | 4.9 |
| | | film | | | | | | | | | | material | | |
| 109 | Example | Thin | 525 | Co | 0.100 | — | 0.000 | 0.090 | 0.080 | 0.020 | 0.800 | Amorphous | 1.85 | 4.1 |
| | | film | | | | | | | | | | material | | |
| 110 | Example | Thin | 550 | Co | 0.100 | — | 0.000 | 0.090 | 0.080 | 0.020 | 0.800 | Amorphous | 1.87 | 3.5 |
| | | film | | | | | | | | | | material | | |
| 111 | Example | Thin | 600 | Co | 0.100 | — | 0.000 | 0.090 | 0.080 | 0.020 | 0.800 | Amorphous | 1.88 | 4.7 |
| | | film | | | | | | | | | | material | | |
| 112 | Example | Thin | 650 | Co | 0.100 | — | 0.000 | 0.090 | 0.080 | 0.020 | 0.800 | Amorphous | 1.88 | 7.1 |
| | | film | | | | | | | | | | material | | |

TABLE 9D

| | | | Heat | | | | | | | | | | | |
|---|---|---|---|---|---|---|---|---|---|---|---|---|---|---|
| | | | treat- | | | | | | | | | | | |
| | Example/ | | ment | (Fe_{(1 - (α+ β))}X1_{α}X2_{β})_{(1 - (a + b + c))}MₐC_{b}X3_{c} | | | | | | | | | | |
| | Compar- | | temper- | X1 | | X2 | | | | | | | | Hc |
| Sample | ative | | ature | | α{1 − | | β{1 − | M = Ta | C | X3 = P | b/ | | Bs | (thin film) |
| Number | Example | Shape | (° C.) | Type | (a + b + c)} | Type | (a + b + c)} | a | b | c | (b + c) | XRD | (T) | (Oe) |
| 113 | Example | Thin | 500 | — | 0.000 | — | 0.000 | 0.090 | 0.080 | 0.020 | 0.800 | Amorphous | 1.73 | 3.5 |
| | | film | | | | | | | | | | material | | |
| 110 | Example | Thin | 550 | Co | 0.100 | — | 0.000 | 0.090 | 0.080 | 0.020 | 0.800 | Amorphous | 1.87 | 3.5 |
| | | film | | | | | | | | | | material | | |
| 114 | Example | Thin | 550 | Co | 0.200 | — | 0.000 | 0.090 | 0.080 | 0.020 | 0.800 | Amorphous | 1.93 | 3.7 |
| | | film | | | | | | | | | | material | | |
| 115 | Example | Thin | 550 | Co | 0.300 | — | 0.000 | 0.090 | 0.080 | 0.020 | 0.800 | Amorphous | 1.95 | 8.3 |
| | | film | | | | | | | | | | material | | |
| 116 | Example | Thin | 550 | Co | 0.400 | — | 0.000 | 0.090 | 0.080 | 0.020 | 0.800 | Amorphous | 1.94 | 14.6 |
| | | film | | | | | | | | | | material | | |
| 117 | Compar- | Thin | 550 | Co | 0.600 | — | 0.000 | 0.090 | 0.080 | 0.020 | 0.800 | Amorphous | 1.86 | 25.1 |
| | ative | film | | | | | | | | | | material | | |
| | Example | | | | | | | | | | | | | |
| 118a | Example | Thin | 550 | — | 0.000 | — | 0.000 | 0.090 | 0.060 | 0.040 | 0.600 | Amorphous | 1.75 | 4.8 |
| | | film | | | | | | | | | | material | | |
| 118 | Example | Thin | 550 | Co | 0.200 | — | 0.000 | 0.090 | 0.060 | 0.040 | 0.600 | Amorphous | 1.87 | 4.6 |
| | | film | | | | | | | | | | material | | |
| 119 | Example | Thin | 550 | Co | 0.400 | — | 0.000 | 0.090 | 0.060 | 0.040 | 0.600 | Amorphous | 1.86 | 8.6 |
| | | film | | | | | | | | | | material | | |
| 120 | Example | Thin | 550 | Co | 0.200 | — | 0.000 | 0.090 | 0.098 | 0.002 | 0.980 | Amorphous | 1.87 | 9.1 |
| | | film | | | | | | | | | | material | | |
| 121 | Example | Thin | 550 | Co | 0.200 | — | 0.000 | 0.090 | 0.090 | 0.010 | 0.900 | Amorphous | 1.92 | 6.2 |
| | | film | | | | | | | | | | material | | |
| 114 | Example | Thin | 550 | Co | 0.200 | — | 0.000 | 0.090 | 0.080 | 0.020 | 0.800 | Amorphous | 1.93 | 3.7 |
| | | film | | | | | | | | | | material | | |
| 122 | Example | Thin | 550 | Co | 0.200 | — | 0.000 | 0.090 | 0.070 | 0.030 | 0.700 | Amorphous | 1.92 | 3.7 |
| | | film | | | | | | | | | | material | | |
| 118 | Example | Thin | 550 | Co | 0.200 | — | 0.000 | 0.090 | 0.060 | 0.040 | 0.600 | Amorphous | 1.87 | 4.6 |
| | | film | | | | | | | | | | material | | |
| 123 | Example | Thin | 550 | Co | 0.200 | — | 0.000 | 0.050 | 0.080 | 0.020 | 0.800 | Amorphous | 2.02 | 14.2 |
| | | film | | | | | | | | | | material | | |
| 124 | Example | Thin | 550 | Co | 0.200 | — | 0.000 | 0.070 | 0.080 | 0.020 | 0.800 | Amorphous | 1.99 | 7.2 |
| | | film | | | | | | | | | | material | | |
| 114 | Example | Thin | 550 | Co | 0.200 | — | 0.000 | 0.090 | 0.080 | 0.020 | 0.800 | Amorphous | 1.93 | 3.7 |
| | | film | | | | | | | | | | material | | |
| 125 | Example | Thin | 550 | Co | 0.200 | — | 0.000 | 0.140 | 0.080 | 0.020 | 0.800 | Amorphous | 1.71 | 4.6 |
| | | film | | | | | | | | | | material | | |
| 126 | Example | Thin | 550 | Co | 0.200 | — | 0.000 | 0.090 | 0.060 | 0.020 | 0.750 | Amorphous | 1.97 | 5.9 |
| | | film | | | | | | | | | | material | | |
| 114 | Example | Thin | 550 | Co | 0.200 | — | 0.000 | 0.090 | 0.080 | 0.020 | 0.800 | Amorphous | 1.93 | 3.7 |
| | | film | | | | | | | | | | material | | |
| 127 | Example | Thin | 550 | Co | 0.200 | — | 0.000 | 0.090 | 0.140 | 0.020 | 0.875 | Amorphous | 1.80 | 3.7 |
| | | film | | | | | | | | | | material | | |
| 114 | Example | Thin | 550 | Co | 0.200 | — | 0.000 | 0.090 | 0.080 | 0.020 | 0.800 | Amorphous | 1.93 | 3.7 |
| | | film | | | | | | | | | | material | | |
| 128 | Example | Thin | 550 | Co | 0.200 | Al | 0.010 | 0.090 | 0.080 | 0.020 | 0.800 | Amorphous | 1.87 | 3.2 |
| | | film | | | | | | | | | | material | | |
| 129 | Example | Thin | 550 | Co | 0.200 | Mn | 0.010 | 0.090 | 0.080 | 0.020 | 0.800 | Amorphous | 1.74 | 13.2 |
| | | film | | | | | | | | | | material | | |
| 130 | Example | Thin | 550 | Co | 0.200 | Ag | 0.010 | 0.090 | 0.080 | 0.020 | 0.800 | Amorphous | 1.88 | 3.8 |
| | | film | | | | | | | | | | material | | |
| 131 | Example | Thin | 550 | Co | 0.200 | Zn | 0.010 | 0.090 | 0.080 | 0.020 | 0.800 | Amorphous | 1.80 | 4.5 |
| | | film | | | | | | | | | | material | | |
| 132 | Example | Thin | 550 | Co | 0.200 | Cu | 0.010 | 0.090 | 0.080 | 0.020 | 0.800 | Amorphous | 1.87 | 3.4 |
| | | film | | | | | | | | | | material | | |
| 133 | Example | Thin | 550 | Co | 0.200 | Cr | 0.010 | 0.090 | 0.080 | 0.020 | 0.800 | Amorphous | 1.76 | 7.3 |
| | | film | | | | | | | | | | material | | |

TABLE 9E

| | | | Heat | | | | | | | | | | | | |
|---|---|---|---|---|---|---|---|---|---|---|---|---|---|---|---|
| | | | treat- | | | | | | | | | | | | |
| | | | ment | (Fe_{(1 - (α+ β))}X1_{α}X2_{β})_{(1 - (a + b + c))}MₐC_{b}X3_{c} | | | | | | | | | | | |
| | Example/ | | tem- | | | | | | | | | | | | Hc |
| | Com- | | per- | X1 | | X2 | | | | | | | | | (thin |
| Sample | parative | | ature | | α{1 − | | β{1 − | M = Ta | C | X3 | | b/ | | Bs | film) |
| Number | Example | Shape | (° C.) | Type | (a + b + c)} | Type | (a + b + c)} | a | b | type | c | (b + c) | XRD | (T) | (Oe) |
| 134 | Example | Thin | 500 | — | 0.000 | — | 0.000 | 0.080 | 0.060 | B | 0.040 | 0.600 | Amorphous | 1.70 | 3.6 |
| | | film | | | | | | | | | | | material | | |
| 135 | Example | Thin | 550 | Co | 0.200 | — | 0.000 | 0.080 | 0.060 | B | 0.040 | 0.600 | Amorphous | 1.90 | 4.2 |
| | | film | | | | | | | | | | | material | | |
| 136 | Example | Thin | 550 | Co | 0.400 | — | 0.000 | 0.080 | 0.060 | B | 0.040 | 0.600 | Amorphous | 1.89 | 16.3 |
| | | film | | | | | | | | | | | material | | |
| 137 | Compar- | Thin | 550 | Co | 0.600 | — | 0.000 | 0.080 | 0.060 | B | 0.040 | 0.600 | Amorphous | 1.86 | 33.7 |
| | ative | film | | | | | | | | | | | material | | |
| | Example | | | | | | | | | | | | | | |
| 138 | Example | Thin | 550 | Co | 0.200 | — | 0.000 | 0.050 | 0.060 | B | 0.040 | 0.600 | Amorphous | 1.96 | 9.3 |
| | | film | | | | | | | | | | | material | | |
| 135 | Example | Thin | 550 | Co | 0.200 | — | 0.000 | 0.080 | 0.060 | B | 0.040 | 0.600 | Amorphous | 1.90 | 4.2 |
| | | film | | | | | | | | | | | material | | |
| 139 | Example | Thin | 550 | Co | 0.200 | — | 0.000 | 0.140 | 0.060 | B | 0.040 | 0.600 | Amorphous | 1.68 | 4.7 |
| | | film | | | | | | | | | | | material | | |
| 140 | Example | Thin | 550 | Co | 0.200 | — | 0.000 | 0.080 | 0.040 | B | 0.040 | 0.500 | Amorphous | 1.94 | 15.9 |
| | | film | | | | | | | | | | | material | | |
| 135 | Example | Thin | 550 | Co | 0.200 | — | 0.000 | 0.080 | 0.060 | B | 0.040 | 0.600 | Amorphous | 1.90 | 4.2 |
| | | film | | | | | | | | | | | material | | |
| 141 | Example | Thin | 550 | Co | 0.200 | — | 0.000 | 0.080 | 0.120 | B | 0.040 | 0.750 | Amorphous | 1.66 | 4.0 |
| | | film | | | | | | | | | | | material | | |
| 142 | Example | Thin | 550 | Co | 0.200 | — | 0.000 | 0.080 | 0.095 | B | 0.005 | 0.950 | Amorphous | 1.83 | 13.3 |
| | | film | | | | | | | | | | | material | | |
| 135 | Example | Thin | 550 | Co | 0.200 | — | 0.000 | 0.080 | 0.060 | B | 0.040 | 0.600 | Amorphous | 1.90 | 4.2 |
| | | film | | | | | | | | | | | material | | |
| 143 | Example | Thin | 550 | Co | 0.200 | — | 0.000 | 0.080 | 0.050 | B | 0.050 | 0.500 | Amorphous | 1.92 | 12.8 |
| | | film | | | | | | | | | | | material | | |
| 144 | Example | Thin | 550 | — | 0.000 | — | 0.000 | 0.090 | 0.080 | Si | 0.020 | 0.800 | Amorphous | 1.62 | 4.7 |
| | | film | | | | | | | | | | | material | | |
| 145 | Example | Thin | 550 | Co | 0.200 | — | 0.000 | 0.090 | 0.080 | Si | 0.020 | 0.800 | Amorphous | 1.82 | 4.9 |
| | | film | | | | | | | | | | | material | | |
| 146 | Example | Thin | 550 | Co | 0.400 | — | 0.000 | 0.090 | 0.080 | Si | 0.020 | 0.800 | Amorphous | 1.84 | 19.6 |
| | | film | | | | | | | | | | | material | | |
| 147 | Compar- | Thin | 550 | Co | 0.600 | — | 0.000 | 0.090 | 0.080 | Si | 0.020 | 0.800 | Amorphous | 1.71 | 47.8 |
| | ative | film | | | | | | | | | | | material | | |
| | Example | | | | | | | | | | | | | | |
| 145 | Example | Thin | 550 | Co | 0.200 | — | 0.000 | 0.090 | 0.080 | Ge | 0.020 | 0.800 | Amorphous | 1.74 | 11.8 |
| | | film | | | | | | | | | | | material | | |

Table 2 showed results of each sample prepared under the same conditions except that an M amount (a) as M=Ta was changed. Each sample having the M amount (a) within a predetermined range became a thin film having suitable magnetic properties. In contrast, Sample No. 14 having an excessively large M amount (a) had an excessively large coercivity Hc.

Table 3 showed results of each sample in which a sum of a C amount (b) and an X3 amount (c) as X3=P (b+c) was fixed to 0.080 and the C amount (b) and the X3 amount (c) were changed with respect to Sample No. 10 in Table 2. Each sample in which the C amount (b), the X3 amount (c), and b/(b+c) were all within a predetermined range became a thin film having suitable magnetic properties. In contrast, Samples No. 19 to 21 in which b/(b+c) was too small had excessively large coercivitys Hc.

Table 4 showed results of each sample in which an M amount (a) as M=Ta was 0.090 and an C amount (b) was changed. Each sample having the C amount (b) within a predetermined range became a thin film having suitable magnetic properties. In contrast, Sample No. 28 having an excessively large C amount had an excessively small saturation magnetic flux density Bs and an excessively large coercivity Hc.

Table 5 showed results of each sample in which an M amount (a) as M=Ta was 0.140 and an C amount (b) was changed. Each sample having the C amount (b) within a predetermined range became a thin film having suitable magnetic properties. In contrast, Sample No. 29 in which the C amount (b) was too small and b/(b+c) was too small had an excessively large coercivity Hc.

Table 6 showed results of each sample in which an X3 amount (c) as X3=P was changed. Each sample having an X3 amount (c) within a predetermined range became a thin film having suitable magnetic properties. In contrast, Sample No. 39 in which the X3 amount was too large and b/(b+c) was too small had an excessively small saturation magnetic flux density Bs and an excessively large coercivity Hc.

Table 7 showed results of each sample in which an M amount (a) as M=Ta, a C amount (b), and/or an X3 amount (c) and/or the type of X3 were changed. Each sample having a composition within a predetermined range became a thin film having suitable magnetic properties.

Table 8 showed results of each sample in which the type of M was changed with respect to Sample No. 10. Each sample having a composition within a predetermined range became a thin film having suitable magnetic properties.

Table 9A showed results of each sample in which a part of Fe was replaced with X1 or X2 with respect to Sample No. 10. Each sample having a composition within a predetermined range became a thin film having suitable magnetic properties.

Table 9B showed results of Sample No. 113 in which a C amount (b) was changed with respect to Sample No. 10, and Sample No. 108 in which a C amount (b) was changed with respect to Sample No. 62. In the Samples No. 10 and 113 containing no Co, when the C amount (b) was increased, both Bs and He decreased. In contrast, in the Samples No. 62 and 108 containing 10 at % of Co, Bs hardly decreased even when the C amount (b) was increased, and He decreased significantly. Therefore, when 10 at % of Co is contained, it is preferable to slightly increase the C amount (b) as compared with a case where Co is not contained.

Table 9C showed results of each sample in which a heat treatment temperature was changed from Sample No. 108. From Table 9C, an optimum heat treatment temperature when 10 at % of Co is contained is 550° C.

Table 9D showed results of each sample in which compositions were changed with respect to Sample No. 110. Table 9E shows results of each sample in which the type of X3 was changed to B, Si or Ge. Each example in which amounts of all components were within a specific range was a thin film having good magnetic properties.

### Experimental Example 3

In Experimental Example 3, both thin film-shaped samples and ribbon-shaped samples were prepared for each composition shown in Table 10, and magnetic properties were compared. Preparation conditions for each sample were the same as in Experimental Example 1.

TABLE 10

| | | | | | | | | | | | Hc | |
|---|---|---|---|---|---|---|---|---|---|---|---|---|
| | Example/ | | | Fe_{(1 - (a + b + c))}MₐC_{b}X3_{c}(α = β = 0) | | | | | | | Thin | |
| Sample | Comparative | | | M = Ta | C | X3 | | b/ | | Bs | film | Ribbon |
| Number | Example | Shape | Fe | a | b | Type | c | (b + c) | XRD | (T) | (Oe) | (A/m) |
| 8 | Example | Thin | 0.870 | 0.050 | 0.060 | P | 0.020 | 0.750 | Amorphous | 1.82 | 12.1 | — |
| | | film | | | | | | | material | | | |
| 9 | Example | Thin | 0.850 | 0.070 | 0.060 | P | 0.020 | 0.750 | Amorphous | 1.84 | 8.7 | — |
| | | film | | | | | | | material | | | |
| 10 | Example | Thin | 0.830 | 0.090 | 0.060 | P | 0.020 | 0.750 | Amorphous | 1.80 | 5.6 | — |
| | | film | | | | | | | material | | | |
| 46 | Example | Thin | 0.850 | 0.070 | 0.040 | B | 0.040 | 0.500 | Amorphous | 1.69 | 3.8 | — |
| | | film | | | | | | | material | | | |
| 78 | Example | Ribbon | 0.870 | 0.050 | 0.060 | P | 0.020 | 0.750 | Amorphous | 1.81 | — | 3.7 |
| | | | | | | | | | material | | | |
| 79 | Example | Ribbon | 0.850 | 0.070 | 0.060 | P | 0.020 | 0.750 | Amorphous | 1.83 | — | 2.8 |
| | | | | | | | | | material | | | |
| 80 | Example | Ribbon | 0.830 | 0.090 | 0.060 | P | 0.020 | 0.750 | Amorphous | 1.79 | — | 1.7 |
| | | | | | | | | | material | | | |
| 84 | Example | Ribbon | 0.850 | 0.070 | 0.040 | B | 0.040 | 0.500 | Amorphous | 1.69 | — | 1.3 |
| | | | | | | | | | material | | | |

The saturation magnetic flux densities Bs of the ribbon under the heat treatment temperature of 600° C. and the saturation magnetic flux densities Bs of thin film under the heat treatment temperature of 500° C. were substantially the same with each other when the ribbon and the film have the same composition to each other. That is, it was confirmed that a condition found in Experimental Example 1 in which the saturation magnetic flux densities Bs of the ribbon and the thin film that had the same composition were substantially the same with each other was applicable even if the composition of the soft magnetic alloy was changed. That is, it was confirmed that a good composition range examined in Experimental Example 2 was applicable not only to a thin film but also to a bulk (ribbon).

Then, each sample of Experimental Example 3 having a composition within a predetermined range had better magnetic properties than each sample of Experimental Example 1 having the composition outside the predetermined range. In addition, the higher a coercivity Hc of a thin film, the higher a coercivity Hc of a ribbon tended to be.

### Experimental Example 4

In Experimental Example 4, ribbons in which compositions and heat treatment temperatures were changed under the production conditions of Experimental Example 1 were prepared. Results are shown in Tables 11A to 11E.

TABLE 11A

| | | Heat | (Fe_{(1-(α+β))}X1_{α}X2_{β})_{(1-(a+b+c))}MₐC_{b}X3_{c} | | | | | | | | | | |
|---|---|---|---|---|---|---|---|---|---|---|---|---|---|
| | Example/ | treatment | X1 | | X2 | | M = | | X3 = | b/ | | | Hc |
| Sample | Comparative | temperature | | α{1 − (a + | | β{1 − (a + | Ta | C | P | (b + | | Bs | (ribbon) |
| Number | Example | (° C.) | Type | b + c)} | Type | b + c)} | a | b | c | c) | XRD | (T) | (A/m) |
| 80 | Example | 600 | — | 0.000 | — | 0.000 | 0.090 | 0.060 | 0.020 | 0.750 | Amorphous material | 1.79 | 1.7 |
| 82 | Example | 600 | — | 0.000 | S | 0.010 | 0.090 | 0.060 | 0.020 | 0.750 | Amorphous material | 1.78 | 2.8 |
| 85 | Example | 600 | — | 0.000 | N | 0.010 | 0.090 | 0.060 | 0.020 | 0.750 | Amorphous material | 1.74 | 3.9 |
| 86 | Example | 600 | — | 0.000 | O | 0.010 | 0.090 | 0.060 | 0.020 | 0.750 | Amorphous material | 1.66 | 5.2 |
| 101 | Example | 600 | — | 0.000 | Al | 0.010 | 0.090 | 0.060 | 0.020 | 0.750 | Amorphous material | 1.76 | 1.8 |
| 102 | Example | 600 | — | 0.000 | Ag | 0.010 | 0.090 | 0.060 | 0.020 | 0.750 | Amorphous material | 1.77 | 2.1 |
| 103 | Example | 600 | — | 0.000 | Zn | 0.010 | 0.090 | 0.060 | 0.020 | 0.750 | Amorphous material | 1.73 | 2.3 |
| 104 | Example | 600 | — | 0.000 | Cu | 0.010 | 0.090 | 0.060 | 0.020 | 0.750 | Amorphous material | 1.80 | 1.9 |
| 105 | Example | 600 | — | 0.000 | Cr | 0.010 | 0.090 | 0.060 | 0.020 | 0.750 | Amorphous material | 1.64 | 3.1 |
| 106 | Example | 600 | Co | 0.100 | — | 0.000 | 0.090 | 0.060 | 0.020 | 0.750 | Amorphous material | 1.81 | 3.3 |
| 107 | Example | 600 | Ni | 0.100 | — | 0.000 | 0.090 | 0.060 | 0.020 | 0.750 | Amorphous material | 1.75 | 2.2 |

TABLE 11B

| | | Heat | | | | | | | | | | | |
|---|---|---|---|---|---|---|---|---|---|---|---|---|---|
| | | treat- | | | | | | | | | | | |
| | Example/ | ment | (Fe_{(1 - (α+ β))}X1_{α}X2_{β})_{(1 - (a + b + c))}MₐC_{b}X3_{c} | | | | | | | | | | |
| | Com- | temper- | X1 | | X2 | | | | | | | | Hc |
| Sample | parative | ature | | α{1 − | | β{1 − | M = Ta | C | X3 = P | b/ | | Bs | (ribbon) |
| Number | Example | (° C.) | Type | (a + b + c)} | Type | (a + b + c)} | a | b | c | (b + c) | XRD | (T) | (Oe) |
| 80 | Example | 600 | — | 0.000 | — | 0.000 | 0.090 | 0.060 | 0.020 | 0.750 | Amorphous | 1.79 | 1.7 |
| | | | | | | | | | | | material | | |
| 106 | Example | 600 | Co | 0.100 | — | 0.000 | 0.090 | 0.060 | 0.020 | 0.750 | Amorphous | 1.81 | 3.3 |
| | | | | | | | | | | | material | | |
| 145 | Example | 600 | — | 0.000 | — | 0.000 | 0.090 | 0.080 | 0.020 | 0.800 | Amorphous | 1.77 | 1.6 |
| | | | | | | | | | | | material | | |
| 146 | Example | 600 | Co | 0.100 | — | 0.000 | 0.090 | 0.080 | 0.020 | 0.800 | Amorphous | 1.81 | 2.2 |
| | | | | | | | | | | | material | | |

TABLE 11C

| | | Heat | (Fe_{(1-(α+β))}X1_{α}X2_{β})_{(1-(a+b+c))}MₐC_{b}X3_{c} | | | | | | | | | | |
|---|---|---|---|---|---|---|---|---|---|---|---|---|---|
| | Example/ | treatment | X1 | | X2 | | M = | | X3 = | b/ | | | Hc |
| Sample | Comparative | temperature | | α{1 − (a + | | β{1 − (a + | Ta | C | P | (b + | | Bs | (ribbon) |
| Number | Example | (° C.) | Type | b + c)} | Type | b + c)} | a | b | c | c) | XRD | (T) | (A/m) |
| 146 | Example | 600 | Co | 0.100 | — | 0.000 | 0.090 | 0.080 | 0.020 | 0.800 | Amorphous material | 1.81 | 2.2 |
| 147 | Example | 625 | Co | 0.100 | — | 0.000 | 0.090 | 0.080 | 0.020 | 0.800 | Amorphous material | 1.86 | 1.7 |
| 148 | Example | 650 | Co | 0.100 | — | 0.000 | 0.090 | 0.080 | 0.020 | 0.800 | Amorphous material | 1.87 | 3.3 |

TABLE 11D

| | Heat | (Fe_{(1-(α+β))}X1_{α}X2_{β})_{(1-(a+b+c))}MₐC_{b}X3_{c} | | | | | | | | | | | |
|---|---|---|---|---|---|---|---|---|---|---|---|---|---|
| | Example/ | treatment | X1 | | X2 | | M = | | X3 = | b/ | | | Hc |
| Sample | Comparative | temperature | | α{1 − (a + | | β{1 − (a + | Ta | C | P | (b + | | Bs | (ribbon) |
| Number | Example | (° C.) | Type | b + c)} | Type | b + c)} | a | b | c | c) | XRD | (T) | (A/m) |
| 145 | Example | 600 | — | 0.000 | — | 0.000 | 0.090 | 0.080 | 0.020 | 0.800 | Amorphous material | 1.77 | 1.6 |
| 147 | Example | 625 | Co | 0.100 | — | 0.000 | 0.090 | 0.080 | 0.020 | 0.800 | Amorphous material | 1.86 | 1.7 |
| 150 | Example | 625 | Co | 0.200 | — | 0.000 | 0.090 | 0.080 | 0.020 | 0.800 | Amorphous material | 1.92 | 1.6 |
| 151 | Example | 625 | Co | 0.400 | — | 0.000 | 0.090 | 0.080 | 0.020 | 0.800 | Amorphous material | 1.94 | 8.8 |
| 152 | Comparative | 625 | Co | 0.600 | — | 0.000 | 0.090 | 0.080 | 0.020 | 0.800 | Amorphous material | 1.74 | 25.3 |
| | Example | | | | | | | | | | | | |

TABLE 11E

| | Heat | (Fe_{(1-(α+β))}X1_{α}X2_{β})_{(1-(a+b+c))}MₐC_{b}X3_{c} | | | | | | | | | | | | |
|---|---|---|---|---|---|---|---|---|---|---|---|---|---|---|
| | Example/ | treatment | X1 | | X2 | | M = | | | | b/ | | | Hc |
| Sample | Comparative | temperature | | α{1 − (a + | | β{1 − (a + | Ta | C | X3 | | (b + | | Bs | (ribbon) |
| Number | Example | (° C.) | Type | b + c)} | Type | b + c)} | a | b | Type | c | c) | XRD | (T) | (A/m) |
| 153 | Example | 600 | — | 0.000 | — | 0.000 | 0.080 | 0.060 | B | 0.040 | 0.600 | Amorphous material | 1.68 | 1.9 |
| 154 | Example | 625 | Co | 0.200 | — | 0.000 | 0.080 | 0.060 | B | 0.040 | 0.600 | Amorphous material | 1.88 | 1.8 |
| 155 | Example | 625 | Co | 0.400 | — | 0.000 | 0.080 | 0.060 | B | 0.040 | 0.600 | Amorphous material | 1.90 | 7.1 |
| 156 | Comparative | 625 | Co | 0.600 | — | 0.000 | 0.080 | 0.060 | B | 0.040 | 0.600 | Amorphous material | 1.92 | 15.7 |
| | Example | | | | | | | | | | | | | |
| 157 | Example | 625 | Co | 0.200 | — | 0.000 | 0.090 | 0.080 | Si | 0.020 | 0.800 | Amorphous material | 1.86 | 4.4 |
| 158 | Example | 625 | Co | 0.200 | — | 0.000 | 0.090 | 0.080 | Ge | 0.020 | 0.800 | Amorphous material | 1.79 | 9.6 |

From Table 11A, each sample in which a composition was within a predetermined range even when a part of Fe was replaced with X1 or X2 became a ribbon having suitable magnetic properties.

Table 11B showed results of Sample No. 145 in which a C amount (b) was changed with respect to Sample No. 80, and Sample No. 146 in which a C amount (b) was changed with respect to Sample No. 106. In the Sample No. 80 containing no Co, both Bs and He decreased slightly when the C amount (b) was increased. In contrast, in the Sample No. 106 containing 10 at % of Co, Bs did not decrease even if the C amount (b) was increased, and He decreased significantly. Therefore, when 10 at % of Co is contained, it is preferable to slightly increase the C amount (b) as compared with a case where Co is not contained.

Table 11C showed results of each sample in which heat treatment temperatures were changed from the Sample No. 146. From Table 11C, an optimum heat treatment temperature when 10 at % of Co is contained is 625° C.

Table 11D showed results of each sample in which compositions were changed with respect to the Sample No. 110. Table 11E showed results of each sample in which the type of X3 was changed to B, Si or Ge. Each example in which amounts of all components were within a specific range was a ribbon having good magnetic properties.

### Experimental Example 5

In Experimental Example 5, with respect to the Sample No. 80, ribbons of Sample Nos. 87 to 96 were prepared by changing a rotation speed of a roll and/or a heat treatment temperature. Results are shown in Table 12.

TABLE 12

| | | a to c, α, β are the same as sample No. 80 | | | | | | |
|---|---|---|---|---|---|---|---|---|
| | | Rotation | | Average particle | Heat | Average particle | After heat | After heat |
| | Example/ | speed | | size of | treatment | size of Fe-based | treatment | treatment |
| Sample | Comparative | of roll | | microcrystals | temperature | nanocrystals | Bs | Hc (ribbon) |
| Number | Example | (m/sec) | XRD | (nm) | (° C.) | (nm) | (T) | (A/m) |
| 80 | Example | 15 | Amorphous material | NO microcrystal | 600 | 9 | 1.79 | 1.7 |
| 87 | Example | 15 | Amorphous material | No microcrystal | 550 | 8 | 1.69 | 1.8 |
| 88 | Example | 15 | Amorphous material | No microcrystal | 450 | 3 | 1.48 | 3.0 |
| 89 | Comparative | 15 | Amorphous material | No microcrystal | 400 | No Fe-based | 1.19 | 11.3 |
| | Example | | | | | nanocrystal | | |
| 91 | Example | 13 | Amorphous material | 0.3 | 450 | 5 | 1.51 | 4.1 |
| 92 | Example | 13 | Amorphous material | 0.3 | 500 | 8 | 1.62 | 3.2 |
| 93 | Example | 13 | Amorphous material | 0.3 | 550 | 10 | 1.70 | 2.4 |
| 94 | Example | 10 | Amorphous material | 10 | 550 | 15 | 1.71 | 2.8 |
| 95 | Example | 10 | Amorphous material | 10 | 600 | 20 | 1.77 | 5.3 |
| 96 | Example | 10 | Amorphous material | 10 | 650 | 25 | 1.78 | 6.9 |

From Table 12, the lower the rotation speed of the roll, the easier it is for microcrystals to form, and the easier it is for microcrystals to grow in a ribbon before heat treatment. In addition, it was confirmed that the higher the heat treatment temperature, the easier it was for a Fe based nanocrystal to form and the easier it was for the Fe based nanocrystal to grow in the ribbon after the heat treatment.

In addition, it was confirmed that when there were no microcrystals before the heat treatment, He tended to be particularly low after the heat treatment.

In addition, Sample No. 89, which had a low heat treatment temperature and did not contain a Fe based nanocrystal after the heat treatment, had an excessively low saturation magnetic flux density Bs and an excessively high coercivity Hc. In addition, Sample Nos. 80 and 87, which had no microcrystal and had an average particle size of Fe based nanocrystal of 5 nm to 30 nm before the heat treatment, had a high saturation magnetic flux density Bs and a low coercivity Hc after the heat treatment compared to Sample No. 88, which had no microcrystal and had an average particle size of Fe based nanocrystal of 3 nm before the heat treatment.

### Experimental Example 6

In Experimental Example 6, powders having compositions shown in Table 13 were prepared.

First, pure metal materials were weighed so as to obtain a base alloy having a composition shown in Table 13. Then, the pure metal materials were vacuum-evacuated in a chamber and then melted by high frequency heating to prepare the base alloy.

Then, the prepared base alloy was heated and melted to obtain a metal in a molten state at 1500° C., and then the metal was injected with the composition shown in Table 13 by a gas atomization method to prepare the powder. The powder was prepared with a nozzle diameter of 1 mm, a molten metal discharge amount of 1 kg/min, and a gas pressure of 7.5 MPa.

It was confirmed whether each of the obtained soft magnetic alloy powders included an amorphous material or a crystal. An amorphization rate X of each ribbon was measured using XRD, and when X was 85% or more, each of the powders included the amorphous material. When X was less than 85%, each of the powders included the crystal. Results are shown in Table 13.

Next, each of the prepared powders was heat-treated at a temperature shown in Table 13 for 60 minutes. An atmosphere during the heat treatment was in an inert atmosphere (Ar atmosphere).

A saturation magnetic flux density Bs of each of the powders after the heat treatment was measured. The saturation magnetic flux density Bs was measured with a vibrating sample magnetometer (VSM) at a maximum applied magnetic field of 20,000 Oe. Results are shown in Table 13.

TABLE 13

| | Example/ | | | Heat | | |
|---|---|---|---|---|---|---|
| Sample | Comparative | | | treatment | | Bs |
| Number | Example | Composition | Shape | temperature | XRD | (T) |
| 2 | Comparative | Fe_{0.735}Si_{0.135}B_{0.09}Nb_{0.03}Cu_{0.01} | Thin film | 500° C. | Amorphous material | 1.26 |
| | Example | | | | | |
| 1 | Comparative | Fe_{0.735}Si_{0.135}B_{0.09}Nb_{0.03}Cu_{0.01} | Ribbon | 600° C. | Amorphous material | 1.23 |
| | Example | | | | | |
| 97 | Comparative | Fe_{0.735}Si_{0.135}B_{0.09}Nb_{0.03}Cu_{0.01} | Powder | 600° C. | Amorphous material | 1.25 |
| | Example | | | | | |
| 4 | Comparative | Fe_{0.94}Nb_{0.07}B_{0.09} | Thin film | 500° C. | Amorphous material | 1.41 |
| | Example | | | | | |
| 3 | Comparative | Fe_{0.84}Nb_{0.07}B_{0.09} | Ribbon | 600° C. | Amorphous material | 1.43 |
| | Example | | | | | |
| 99 | Comparative | Fe_{0.94}Nb_{0.07}B_{0.09} | Powder | 600° C. | Amorphous material | 1.43 |
| | Example | | | | | |
| 10 | Example | Fe_{0.83}Ta_{0.09}C_{0.06}P_{0.02} | Thin film | 500° C. | Amorphous material | 1.80 |
| 80 | Example | Fe_{0.83}Ta_{0.09}C_{0.06}P_{0.02} | Ribbon | 600° C. | Amorphous material | 1.79 |
| 98 | Example | Fe_{0.83}Ta_{0.09}C_{0.06}P_{0.02} | Powder | 600° C. | Amorphous material | 1.79 |
| 134 | Example | Fe_{0.82}Ta_{0.08}C_{0.06}B_{0.04} | Thin film | 500° C. | Amorphous material | 1.70 |
| 153 | Example | Fe_{0.82}Ta_{0.08}C_{0.06}B_{0.04} | Ribbon | 600° C. | Amorphous material | 1.68 |
| 159 | Example | Fe_{0.82}Ta_{0.08}C_{0.06}B_{0.04} | Powder | 600° C. | Amorphous material | 1.70 |
| 114 | Example | Fe_{0.61}Co_{0.20}Ta_{0.09}C_{0.08}P_{0.02} | Thin film | 550° C. | Amorphous material | 1.93 |
| 150 | Example | Fe_{0.61}Co_{0.20}Ta_{0.09}C_{0.08}P_{0.02} | Ribbon | 625° C. | Amorphous material | 1.92 |
| 160 | Example | Fe_{0.61}Co_{0.20}Ta_{0.09}C_{0.08}P_{0.02} | Powder | 625° C. | Amorphous material | 1.92 |

From Table 13, it was confirmed that saturation magnetic flux densities Bs of a ribbon with a heat treatment temperature of 600° C. (625° C. for Sample No. 150), saturation magnetic flux densities Bs of a thin film with the heat treatment temperature of 500° C. (550° C. for Sample No. 114), and saturation magnetic flux densities Bs of a powder with a heat treatment temperature of 600° C. (625° C. in Sample No. 160) that were substantially the same with each other when the ribbon, the thin film and the powder have the same composition to each other. That is, from crystal states and magnetic properties of each of the powders produced under production conditions of Experimental Example 6, crystal states and magnetic properties of the ribbons and the thin films produced under the production conditions of Experimental Examples 1 to 5 can be known. On the contrary, the crystal states and magnetic properties of the powders produced under the production conditions of Experimental Example 6 can be known from the crystal states and magnetic properties of the ribbons or thin films prepared under the production conditions of Experimental Examples 1 to 5.

In addition, each sample of Sample Nos. 10, 80, and 98 having a composition within a predetermined range had a higher saturation magnetic flux density Bs than each sample of Sample Nos. 2, 1, and 97 having a composition outside a predetermined range. Each sample of Sample Nos. 134, 153, and 159 having a composition within a predetermined range and each sample of Sample Nos. 114, 150, and 160 having a composition within a predetermined range also had a higher saturation magnetic flux density Bs than each sample of the Sample Nos. 2, 1, and 97 having the composition outside the predetermined range.

In addition, coercivitys He between samples having the same shape as each other were compared between each sample of Sample Nos. 4, 3, and 99 and each sample of Sample Nos. 10, 80, and 98. Each sample of Sample Nos. 10, 80, and 98 having a composition within a predetermined range has a lower coercivity Hc than each sample of Sample Nos. 4, 3, and 99 having a composition outside a predetermined range.

1-9. (canceled)

10. A soft magnetic alloy comprising a composition having a formula (Fe(1−(α+β))X1αX2β)(1−(a+b+c))MaCbX3c, in which
X1 represents at least one selected from a group consisting of Co and Ni,
X2 represents at least one selected from a group consisting of Al, Mn, Ag, Zn, Sn, As, Sb, Cu, Cr, Bi, N, O, S, and rare earth elements,
M represents at least one selected from a group consisting of Ta, V, Zr, Hf, Ti, Nb, Mo, and W,
X3 represents at least one selected from a group consisting of P, B, Si, and Ge, and
0≤a≤0.140,
0.005≤b≤0.200,
0<c≤0.180,
0.300≤b/(b+c)<1.000,
0≤α(1−(a+b+c))≤0.400,
β≥0,
0≤α+β≤0.50 are satisfied, wherein
the soft magnetic alloy has a structure including a Fe based nanocrystal.

11. A soft magnetic alloy comprising a composition having a formula (Fe(1−(α+β))X1αX2β)(1−(a+b+c))MaCbX3c, in which
X1 represents at least one selected from a group consisting of Co and Ni,
X2 represents at least one selected from a group consisting of Al, Mn, Ag, Zn, Sn, As, Sb, Cu, Cr, Bi, N, O, S, and rare earth elements,
M represents at least one selected from a group consisting of Ta, V, Zr, Hf, Ti, Nb, Mo, and W,
X3 represents at least one selected from a group consisting of P, B, Si, and Ge, and
0≤a≤0.140,
0.005≤b≤0.200,
0<c≤0.180,
0.300≤b/(b+c)<1.000,
0≤α(1−(a+b+c))≤0.400,
β≥0,
0≤α+β≤0.50 are satisfied, wherein
the soft magnetic alloy has a nano-heterostructure in which a microcrystal is present in an amorphous material.

12. The soft magnetic alloy according to claim 10, wherein b≥c.

13. The soft magnetic alloy according to claim 10, wherein 0.050≤a≤0.140.

14. The soft magnetic alloy according to claim 10, wherein 0.730≤(1−(a+b+c))≤0.930.

15. The soft magnetic alloy according to claim 10, having a ribbon shape.

16. The soft magnetic alloy according to claim 10, having a shape in a powder form.

17. The soft magnetic alloy according to claim 10, having a thin film shape.

18. A magnetic component made of the soft magnetic alloy according to claim 10.

19. The soft magnetic alloy according to claim 11, wherein b≥c.

20. The soft magnetic alloy according to claim 11, wherein 0.050≤a≤0.140.

21. The soft magnetic alloy according to claim 11, wherein 0.730≤(1−(a+b+c))≤0.930.

22. The soft magnetic alloy according to claim 11, having a ribbon shape.

23. The soft magnetic alloy according to claim 11, having a shape in a powder form.

24. The soft magnetic alloy according to claim 11, having a thin film shape.

25. A magnetic component made of the soft magnetic alloy according to claim 11.
